(19) United States
(12) Patent Application Publication
(10) Pub. No.: US 2025/0149277 A1
(43) Pub. Date: May 8, 2025

(54) INTEGRATED THERMAL SWITCHING AND SENSING DEVICES AND METHODS

(71) Applicant: BOURNS, INC., Riverside, CA (US)

(72) Inventors: Jordan Edwards, Carson, CA (US); Jason Heinrich, San Juan Capistrano, CA (US); Patrocinio Ryan Reyes, III, Riverside, CA (US); Nicholas Duran, Riverside, CA (US); Ogechukwu M. Ogbechie, Riverside, CA (US); Gordon Lee Bourns, Riverside, CA (US); Cathal Sheehan, Cork (IE)

(21) Appl. No.: 18/929,037

(22) Filed: Oct. 28, 2024

Related U.S. Application Data
(60) Provisional application No. 63/596,207, filed on Nov. 3, 2023.

(51) Int. Cl. H01H 37/72; G01K 7/22; H01H 37/08

(52) U.S. Cl. CPC H01H 37/72; G01K 7/22; H01H 37/08

(57) ABSTRACT

A temperature-sensitive connector is disclosed. The connector can include a connector body and a first terminal to connect to a terminal of an electronic component being thermally controlled and a second terminal to connect to a terminal of an electronic thermal control device. The connector can include at least one conductor mounted in the connector body to convey a signal from the electronic component being thermally controlled to the electronic thermal control device. A thermal switching and sensing device can be integrated into the connector body to electrically connect to the first terminal and the second terminal. The integrated thermal switching and sensing device can include a thermally activated switch element connected in parallel with a thermal sensor.

### RELATED APPLICATIONS

This application claims the priority benefit of U.S. Provisional Patent Application 63/596,207 filed on Nov. 3, 2023, entitled “INTEGRATED THERMAL SWITCHING AND SENSING DEVICES AND METHODS,” which is incorporated by reference herein in its entirety.

### BACKGROUND

### Field

The field relates to integrated thermal switching and sensing devices, particularly, integrated thermal switching and sensing devices comprising one or more thermal switches, for example Thermal Cutoffs (TCO's) and thermal sensors, for example, thermistors (NTC's and PTC's).

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In various types of electrical systems, components may experience over-temperature and/or over-current faults which negatively affect the operation and reliability of the larger electrical system. Thermal cutoff devices may be used to protect the larger system as well as provide additional functions.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these implementations are intended to be within the scope of the invention herein disclosed. These and other implementations will become readily apparent to those skilled in the art from the following detailed description of the preferred implementations having reference to the attached figures, the invention not being limited to any particular preferred implementations disclosed.

In some implementations, a temperature-sensitive connector can include: a connector body including a first terminal configured to mechanically and electrically connect with a thermally controlled electrical component and a second terminal configured to mechanically and electrically connect with an electrical thermal control device; at least one conductor within the connector body and connected to the first and second terminals and configured to convey electrical current and electrical signals between the thermally controlled electrical component and the electrical thermal control device; and a thermal switching device within the connector body mechanically and electrically connected by the conductor to the first and second terminals, the thermal switching device including a thermally activated switch element connected mechanically and electrically in parallel by a pair of internal conductors to a thermal sensor element having a variable resistance; wherein the thermal switching device has a normal operating configuration in which a majority of the current flows through the thermally activated switch element, thereby generating normal status signal indicating that the thermally controlled electrical component is operating within a predetermined temperature range; and wherein the thermal switching device has a fault condition triggered at a predetermined threshold temperature in which the thermally activated switch element switches to an open configuration, thereby generating a first thermal alert status signal that the threshold temperature has been exceeded, and in which the current flows through the thermal sensor element, thereby generating a second thermal alert status signal indicative of a temperature of the thermally controlled electrical component.

In some implementations, the temperature-sensitive connector is configured to be attached to circuitry configured to implement interventions based at least in part on the generated normal thermal status signal, the first thermal alert status signal, and the second thermal alert status signals. In some implementations, the intervention associated with the determined temperature initiates a response by the thermally controlled electrical component to perform an action. In some implementations, the action includes disconnecting the thermally controlled electrical component from a power source. In some implementations, the circuitry is configured to implement an intervention based at least in part on the second thermal status signal from a second thermal sensor, e.g. a thermistor. In some implementations, the circuitry monitors a temperature of the thermally activated switch element at temperatures above the fault condition.

In some implementations, the thermally controlled electrical component includes at least one of a battery array, a battery cell, a motor, a semiconductor, an inductor, a transformer, a housing of an electronic component, and an electrical system. In some implementations, the normal status signal includes continuous digital normal status signal. In some implementations, the first thermal alert status includes a digital first thermal alert status signal. In some implementations, the second thermal alert includes a continuous, analog second thermal alert status signal. In some implementations, the temperature of the thermally controlled electrical component is contemporaneous.

In some implementations, the electrical thermal control device includes at least one of a battery management system (BMS), a motor control, and a thermal management system. In some implementations, the thermally activated switch element is a thermal cutoff (TCO). In some implementations, the thermally activated switch element is a bimetal thermal cutoff (TCO). In some implementations, the thermal sensor element includes a thermistor. In some implementations, the thermistor includes a Ceramic PTC, Ceramic NTC, Polymeric PTC, silicon silistor, or other thermal sensor.

In some implementations, the temperature-sensitive connector includes an integrated thermal switching device, wherein the integrated thermal switching device includes two or more terminals connected to a second thermal sensor element not electrically connected to the integrated thermal switching device. In some implementations, the integrated thermal switching device includes a negative temperature coefficient (NTC) thermistor, wherein the NTC thermistor includes at least two terminals for conducting current in addition to the two electrically independent terminals of the thermal switching device, wherein a resistance value of the NTC thermistor is configured to calculate an ambient temperature of the temperature-sensitive connector. In some implementations, an average of value of the resistance of the integrated thermal switching device and the resistance of the NTC thermistor is configured to calculate the temperature of the temperature-sensitive connector.

In some implementations, in the normal operating condition, the signal conveyed by the at least one conductor to the electrical thermal control device includes a voltage status signal. In some implementations, the thermal switching device is configured to provide a normal-temperature signal to the electrical thermal control device by conveying the signal from the at least one conductor to the electrical thermal control device when the temperature of the terminal is below a threshold temperature.

In some implementations, the thermally activated switch element is manually resettable. In some implementations, the temperature-sensitive connector includes a user interface to manually reset the thermally activated switch element when engaged by a user. In some implementations, the thermally activated switch element is automatically resettable. In some implementations, the thermally activated switch element automatically resets to a resistance between 0.02 ohms and 0.06 ohms.

In some implementations, the thermally activated switch element includes a bimetallic dome-shaped switch element. In some implementations, the temperature-sensitive connector includes a conductive ring to mechanically and thermally connect the connector body to the terminal. In some implementations, the temperature-sensitive connector is configured for voltage sensing. In some implementations, the temperature-sensitive connector is configured for voltage sensing of a battery array. In some implementations, the temperature-sensitive connector is configured to monitor the temperature of a charging connector.

In some implementations, the temperature-sensitive connector is configured to monitor the temperature of a charging connector for electric vehicles. In some implementations, the predetermined temperature threshold is between 45° C. and 95° C. In some implementations, the predetermined temperature threshold 55° C. and 77° C. for lithium-ion batteries. In some implementations, the transition between the normal operating condition and the fault condition modifies the signal to the electrical thermal control device.

In some implementations, the thermal switching device includes a second thermal sensor element in parallel with the thermally activated switch element. In some implementations, the second thermally activated switch element is electrically connected to the thermally activated switch element in series. In some implementations, the second thermal sensor element generates heat as a current passes through the second thermal sensor element to cause the thermally activated switch element to trip to an open configuration when the temperature exceeds a characteristic threshold and switches to a closed condition from the open condition once the temperature falls below a reset threshold.

In some implementations, the second thermal sensor element includes a negative temperature coefficient thermistor (NTC), a positive temperature coefficient thermistor (PTC), a silistor, or a thermal temperature sensor. In some implementations, the thermal sensor element includes ceramic, plastic, or silicon. In some implementations, a thermal cutoff element (TCO) configured to provide a signal to an electrical thermal control device can include: a thermally activated switch element, and a thermal sensor element in parallel with the thermally activated switch element and in electrical and mechanical connection with the thermally activated switch element; wherein the thermally activated switch element has a first operating condition in which a signal is conveyed by the TCO to the electrical thermal control device includes a voltage status signal, and the thermally activated switch has a second operating condition in which circuitry of the electrical thermal control device determines a temperature of a portion of a device being thermally controlled based at least in part on a measured resistance of the thermal sensor element.

In some implementations, the thermal sensor element includes a negative temperature coefficient thermistor (NTC), a positive temperature coefficient thermistor (PTC), a silistor, or a thermal temperature sensor. In some implementations, the thermal sensor element includes ceramic, plastic, or silicon. In some implementations, the circuitry is configured to determine the resistance of the thermistor.

In some implementations, the thermally activated switch element is manually resettable. In some implementations, the TCO includes a user interface to manually reset the thermally activated switch element when engaged by a user. In some implementations, the thermally activated switch element is automatically resettable. In some implementations, the thermally activated switch element automatically resets to a resistance between 0.02 ohms and 0.06 ohms.

In some implementations, the thermally activated switch element includes a bimetallic dome-shaped switch element. In some implementations, the TCO includes a conductive ring to mechanically and thermally connect the TCO to the electrical thermal control device.

In some implementations, the circuitry is configured to generate a status signal based on the determined temperature, and wherein the status signal initiates a response by the electrical thermal control device to perform an action. In some implementations, the response associated with the determined temperature initiates a warning alarm to an operator.

In some implementations, the TCO is configured for voltage sensing. In some implementations, the device includes a battery array. In some implementations, the device includes a battery array and the TCO is configured for voltage sensing of the battery array. In some implementations, the TCO is configured to monitor the temperature of a charging connector. In some implementations, the TCO is configured to monitor the temperature of a charging connector for electric vehicles.

In some implementations, the thermal switching device includes a second thermal sensor element in parallel with the thermally activated switch element. In some implementations, the second thermal sensor element is electrically connected to the thermal sensor element in series. In some implementations, the second thermal sensor element generates heat as a current passes through the second thermal sensor element to cause the thermally activated switch element to trip to an open configuration when the temperature exceeds a characteristic threshold and switches to a closed condition from the open condition once the temperature falls below a reset threshold. In some implementations, the second thermal sensor element includes a negative temperature coefficient thermistor (NTC), a positive temperature coefficient thermistor (PTC), a silistor, or a thermal temperature sensor. In some implementations, the second thermal sensor element includes ceramic, plastic, or silicon.

In some implementations, a method of determining a temperature of a connector body configured to mechanically connect to a thermally controlled electrical component can include: in a normal operating condition of a thermal switching device, monitoring a voltage of the thermally controlled electrical component; in a fault condition of the thermal switching device, monitoring a resistance of a thermal sensor element of the thermal switching device after the thermal switching device reaches a predetermined threshold temperature and switches to the fault condition; determining a change in the monitored resistance of the thermal sensor element using circuitry; generating a status signal based on at least the monitored resistance; and conveying the status signal to an electrical thermal control device and prompting an intervention.

In some implementations, the method includes flowing a current through a thermally activated switch element of the thermal switching device, the thermally activated switch element in parallel with a thermal sensor element, wherein the thermal switching device is connected to the connector body. In some implementations, the method includes transitioning the thermally activated switch element to an open configuration. In some implementations, the method includes monitoring the resistance of the thermal sensor element of the thermal switching device at temperatures above the fault condition.

In some implementations, the method includes providing a normal-temperature signal to the electrical thermal control device in the normal operating condition of the thermal switching device. In some implementations, the method includes resetting the thermal switching device. In some implementations, the thermal switching device is manually resettable. In some implementations, the thermal switching device includes a user interface to manually reset the thermal switching device when engaged by a user. In some implementations, the thermal switching device is automatically resettable. In some implementations, the thermal switching device automatically resets to a resistance between 0.02 ohms and 0.06 ohms.

In some implementations, prompting the intervention includes generating an alarm. In some implementations, prompting the intervention includes disconnecting the thermally controlled electrical component from a power source. In some implementations, the method includes determining a corresponding temperature to the monitored resistance of the thermal sensor element.

In some implementations, an electrical system can include: a thermal switching device including a thermally activated switch element and a thermal sensor element in parallel with the thermally activated switch element, wherein the thermal switching device has an open configuration in which current flows through the thermal sensor element, and wherein the thermally activated switch element has a closed condition triggered at a predetermined threshold temperature of the thermal sensor element in which the thermally activated switch element is in a closed configuration; a bypass line configured to electrically connect to the terminal of a power supply, wherein the power supply provides power to a device; a relay including a first relay terminal in electrical communication with the thermal sensor element and a second terminal in electrical communication with the bypass line, wherein the relay includes a relay switch; and a magnetic coil in electrical communication with the thermally activated switch; wherein the electrical system includes an inrush current limiting configuration and a normal operating configuration.

In some implementations, the inrush current limiting configuration, the thermal switching device is in the open configuration and current passes through the thermal sensor element to the device connected to the first terminal of the relay. In some implementations, the initial inrush of current is reduced by the thermal sensor element. In some implementations, if the temperature of the thermal switching device exceeds a threshold temperature, the electrical system moves to the normal configuration and the thermal switching device closes to connect the power supply to the magnetic coil to excite the magnetic coil, the excited magnetic coil causing the relay switch to connect to the second relay terminal, with current passing from the power supply to the electrical device.

In some implementations, the thermal switching device is in thermal communication with the thermal sensor element. In some implementations, the thermal sensor element includes a negative temperature coefficient thermistor (NTC), a positive temperature coefficient thermistor (PTC), a silistor, or a thermal temperature sensor. In some implementations, the thermal sensor element includes ceramic, plastic, or silicon. In some implementations, the thermally activated switch element is manually resettable. In some implementations, the electrical system includes a user interface to manually reset the thermally activated switch element when engaged by a user. In some implementations, the thermally activated switch element is automatically resettable. In some implementations, the thermally activated switch element includes a bimetallic dome-shaped switch element.

In some implementations, the power supply includes an alternating current (AC) source. In some implementations, the electrical system includes a connector body configured to mechanically connect to a terminal of the power supply. In some implementations, the thermal switching device is mounted to the connector body to electrically couple to the terminal.

In some implementations, an electrical system can include: a thermal switching device including a thermally activated switch element and a thermal sensor element and a second thermal sensor element in parallel with the thermally activated switch element, wherein the thermal sensor element and the second thermal sensor element are connected in series, wherein the thermal switching device has an open configuration in which current flows through the thermal sensor element and the second thermal sensor element, and wherein the thermally activated switch element has a closed condition triggered at a predetermined threshold temperature of the second thermal sensor element in which the thermally activated switch element is in a closed configuration; wherein the electrical system includes an inrush current limiting configuration and a normal operating configuration; wherein in the inrush current limiting configuration, the thermal switching device is in the open configuration and current passes through the thermal sensor element and through the second thermal sensor element to a device; and wherein in the normal operating configuration, if the temperature of the thermal switching device exceeds a threshold temperature, the electrical system moves to the normal configuration and the thermal switching device closes with current passing from a power supply to an electrical device.

In some implementations, the initial inrush of current is reduced by the thermal sensor element. In some implementations, the thermal switching device is in thermal communication with the thermal sensor element. In some implementations, the thermal sensor element includes a negative temperature coefficient thermistor (NTC), a positive temperature coefficient thermistor (PTC), a silistor, or a thermal temperature sensor. In some implementations, the thermal sensor element includes ceramic, plastic, or silicon. In some implementations, the thermally activated switch element is manually resettable. In some implementations, the electrical system includes a user interface to manually reset the thermally activated switch element when engaged by a user. In some implementations, the thermally activated switch element is automatically resettable. In some implementations, the thermally activated switch element includes a bimetallic dome-shaped switch element.

In some implementations, the power supply includes an alternating current (AC) source. In some implementations, the electrical system includes a microcontroller to indicate whether the thermally activated switch element is in an open or closed configuration. In some implementations, if the thermally activated switch element is in the closed configuration, the thermal sensor element and second thermal sensor element are bypassed.

In some implementations, the electrical system includes a connector body configured to mechanically connect to a terminal of the power supply wherein the power supply provides power to the device. In some implementations, the thermal switching device is mounted to the connector body to electrically couple to the terminal.

### BRIEF DESCRIPTION OF THE DRAWINGS

These and other features, aspects, and advantages of the disclosure are described with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1A is a schematic system diagram of a portion of an electrical system, according to one implementation.

FIG. 1B is a schematic system diagram of an electrical system, according to another implementation.

FIG. 2A is an enlarged, schematic diagram of a portion of the electrical system shown in FIG. 1A.

FIG. 2B is another enlarged, schematic diagram of a portion of the electrical system shown in FIG. 1A, according to another implementation.

FIG. 3A is a schematic side sectional view of a thermal switching device in a normal operating condition, according to various embodiments.

FIG. 3B is a schematic diagram of the thermal switching device shown in FIG. 3A.

FIG. 4A is a schematic side sectional view of the thermal switching device of FIG. 3A in a fault condition.

FIG. 4B is a schematic diagram of the thermal switching device shown in FIG. 3A.

FIG. 5 is a graph that shows the current and temperature at which exemplary switches trip from a normal operating condition to a fault condition, according to various embodiments.

FIG. 6 is a schematic graph that shows the relationship between temperature and resistance of an exemplary positive temperature coefficient (PTC) thermistor, according to various embodiments.

FIG. 7A is a graph illustrating the temperature vs. logarithmic resistance curve for an exemplary NTC thermistor and an exemplary PTC thermistor.

FIG. 7B is a graph illustrating the temperature vs. logarithmic resistance curve for an exemplary PTC thermistor and an exemplary NTC thermistor.

FIG. 8A is a schematic diagram of a portion of an electrical system, according to various implementations.

FIG. 8B is another schematic diagram of a portion of an electrical system, according to another implementation.

FIG. 9A is a schematic diagram of a portion of an electrical system, according to various implementations.

FIG. 9B is another schematic diagram of a portion of an electrical system, according to various implementations.

FIG. 10A is a schematic diagram of a portion of an electrical system, according to various implementations.

FIG. 10B is another schematic diagram of a portion of an electrical system, according to various implementations.

FIG. 11A is a schematic diagram of a portion of an electrical system having an externally mounted discrete device, according to various implementations.

FIG. 11B is another schematic diagram of a portion of an electrical system having an externally mounted discrete device, according to various implementations.

FIG. 11C illustrates an example externally mounted discrete device as shown in FIGS. 11A and 11B.

FIG. 12A is a schematic diagram of a portion of an electrical system, according to various implementations.

FIG. 12B is another schematic diagram of a portion of an electrical system, according to various implementations.

FIG. 13 illustrates an example schematic diagram of a thermal switching device for electrical system, according to some implementations.

FIG. 14 illustrates an example process of any of the electrical systems mentioned herein for determining a temperature of a connector body.

FIG. 15A illustrates example schematic diagrams of electrical system for managing overcurrent conditions from an inrush current event having a thermal switching device in an inrush current limiting state, according to various implementations.

FIG. 15B illustrates example schematic diagrams of an electrical system for managing overcurrent conditions from an inrush current event having a thermal switching device in a normal operating state, according to various implementations.

FIG. 16 illustrates an example schematic diagrams of electrical system for managing overcurrent conditions from an inrush current event having one or more thermal switching devices, according to various implementations.

FIG. 17 illustrates an example schematic diagrams of an electrical system of an application for managing overcurrent conditions from an inrush current event having one or more thermal switching devices as shown in FIG. 16, according to various implementations.

### DETAILED DESCRIPTION

Although several implementations, examples, and illustrations are disclosed below, it will be understood by those of ordinary skill in the art that the inventions described herein extend beyond the specifically disclosed implementations, examples, and illustrations and includes other uses of the inventions and obvious modifications and equivalents thereof. Implementations are described with reference to the accompanying figures, wherein like numerals refer to like elements throughout. The terminology used in the description presented herein is not intended to be interpreted in any limited or restrictive manner simply because it is being used in conjunction with a detailed description of some specific embodiments of the inventions. In addition, implementations can comprise several novel features. No single feature is solely responsible for its desirable attributes or is essential to practicing the inventions herein described.

Various implementations disclosed herein relate to a connector with an integrated thermal switching device, for example, a thermal cutoff (TCO), configured to detect overtemperature and/or overcurrent conditions in a thermally controlled electrical component, for example a power consuming device, and to relay that detection to an electronic thermal control device such as a battery management system (BMS). In various implementations, a temperature-sensitive or a current-sensitive connector is disclosed. The connector can include a connector body and at least one conductor mounted to the connector body and configured to convey a signal by which the temperature of a thermally controlled electrical component, which can be measured contemporaneously, is determined to have exceeded a threshold level by an electronic thermal control device. The connector can include a thermal switching device, for example a TCO in parallel with a thermistor, inside the connector body and thermally coupled to a terminal of a battery pack or a battery cell. The thermal switching device can be configured to provide an overtemperature signal to the electronic thermal control device by interrupting a voltage or current to provide a signal to be conveyed by the at least one conductor when a temperature of the thermally controlled electrical component exceeds a threshold trip temperature. In various implementations, for example, the signal conveyed to the electronic thermal control device can be created by a change in resistance (e.g., a sudden increase in resistance of the thermal switch device or TCO in the connector body). The electronic device can be configured to interpret the signal as an increase in the thermally controlled electrical component temperature and can prompt an alarm indicating an overtemperature condition. In various implementations, the thermal control device can shut down the thermally controlled electrical component in response to the alarm. The threshold temperature can be tuned and set in advance for the device by selection of materials and dimensions of the thermal switch device.

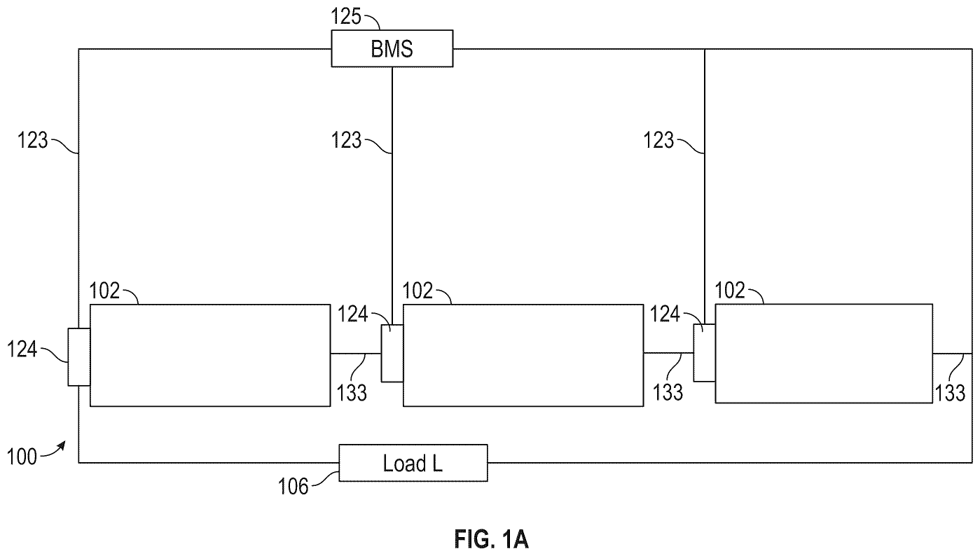

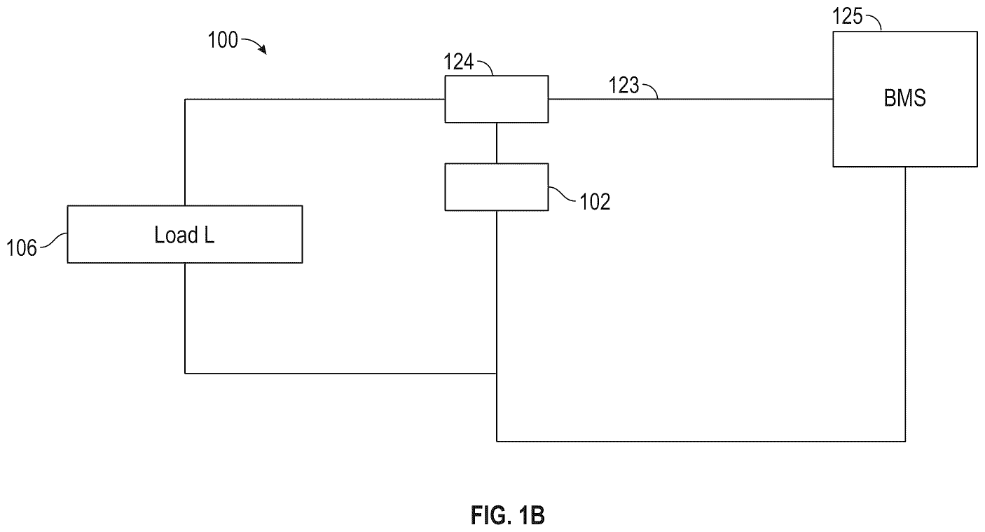

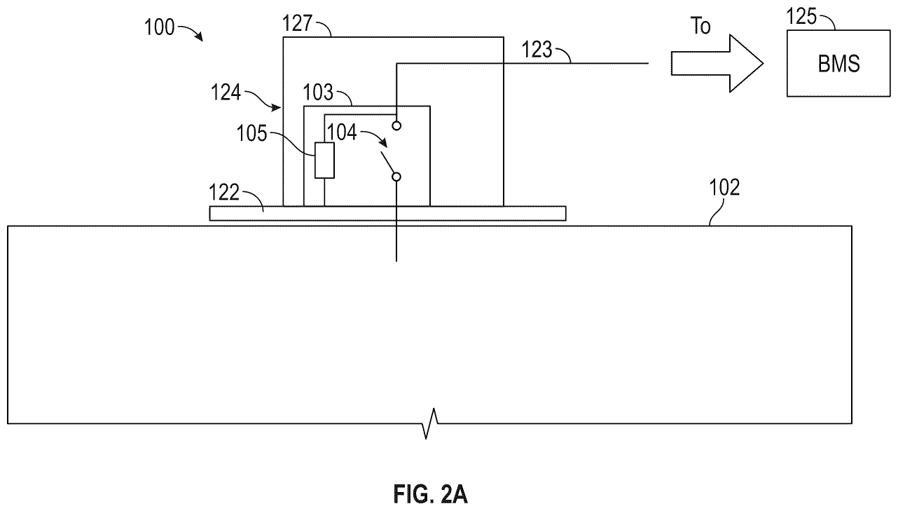

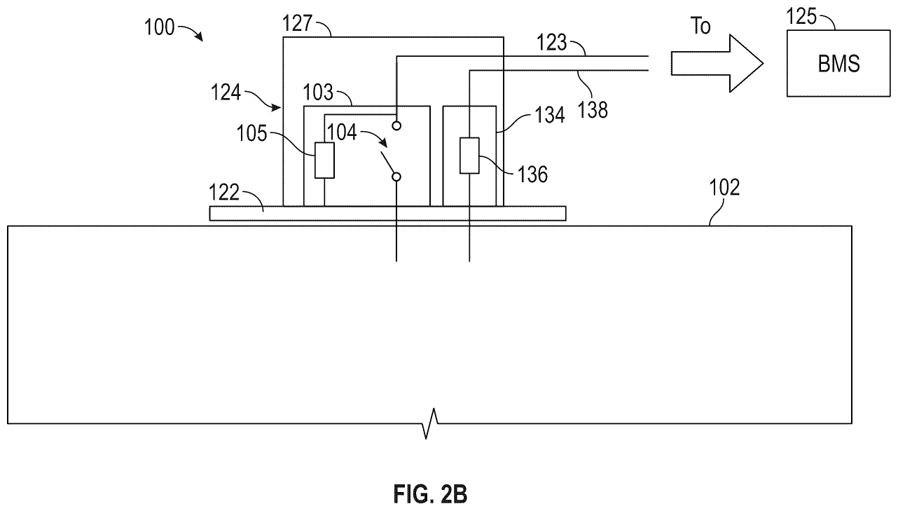

FIG. 1A is a schematic system diagram of a portion of an electrical system 100, according to one implementation. FIG. 2A is an enlarged, schematic diagram of a portion of the electrical system 100 shown in FIG. 1A. The illustrated portion of the electrical system 100 can supply electrical power from a thermally controlled electrical component 102 (e.g., power supply, battery cell, motor, semiconductor device, etc.) to a power consumption device 106 (which may also be referred to herein as LOAD L), such as an electric vehicle, an electric bicycle, power tools, etc. The thermally controlled electrical component 102 can include a plurality of battery cells and the like arranged in series. For example, the electrical system 100 of FIG. 1A can include 144 battery cells in series. In FIG. 1A, an electronic thermal control device 125 (which may also be referred to herein as a thermal control device) (e.g., battery management system (BMS)) is electrically connected to a thermally controlled electrical component 102 by way of corresponding voltage status signaling lines (also referred to as “status lines 123” herein). The thermally controlled electrical component 102 can comprise one or more battery cells in various embodiments. The electronic thermal control device 125 can comprise processing circuitry. In some implementations, the processing circuitry can include circuitry to define one or more management controllers. The status line 123 can electrically connect the thermally controlled electrical component 102 with the electronic thermal control device 125. The approximate voltage of the thermally controlled electrical component 102 can be provided to the electronic thermal control device 125 along the status line 123. Furthermore, a connector 124 can electrically and mechanically connect the status line 123 to the thermally controlled electrical component 102. In some implementations, the connector 124 can monitor the temperature of a charging connector. For example, the connector 124 can monitor the temperature of a charging connector, e.g., for an electric vehicle. In some implementations, the connector can monitor a battery array. Further, as shown in FIG. 1A, a conductive bus bar 133 can be provided to electrically connect a positive terminal of each thermally controlled electrical component 102 to a negative terminal of an adjacent thermally controlled electrical component 102.

In the implementation of FIGS. 1A and 2A, the connector 124 can include a thermal switching device 103 coupled to and/or formed within a connector body 127 of the connector 124, as shown in FIG. 2A. The connector 124 (e.g., the connector body 127) can comprise an electrical conductor (such as a metal) that electrically and mechanically connects to the status line 123. As shown in FIG. 2A, the thermal switching device 103 and the connector body 127 can mechanically and electrically connect to the thermally controlled electrical component 102 by way of an intervening electrically conductive ring 122, or by another conductive fastening device. For example, a nut or other fastener can clamp the conductive ring 122 between the connector body 127 and the thermally controlled electrical component 102. Skilled artisans will understand that additional ways of connecting the connector body 127 and thermal switching device 103 to the thermally controlled electrical component 102 may be suitable.

In the implementations shown in FIGS. 1A and 2A, the thermal switching device 103 can be in electrical connection with the thermally controlled electrical component 102, for example a power supply. In some implementations, as shown in FIG. 2A, the thermal switching device 103 can be in electrical contact with the thermally controlled electrical component 102 by way of an intervening conductive ring 122 or other conductive fastening device. In some implementations, an adhesive may also be provided between the thermal switching device 103 and the ring 122. The thermally activated switch element 104 (which may also be referred to herein as a thermal switch) can further be electrically and/or mechanically connected in parallel with a thermal sensor element 105 (e.g., a thermistor).

The thermal switching device 103 can comprise a thermal switch 104, such as a thermally activated bimetal switch, configured to move from a normally closed condition to an open condition when a temperature of the thermal sensor element 105 exceeds a characteristic temperature threshold or vice versa. The thermal switching device 103 can serve as a thermal fuse and/or a thermal cutoff (TCO) device. The thermal switch 104 can be configured to remain in the normally closed or normally open condition when the temperature of the thermal sensor element 105 is less than the temperature threshold. In the normally closed condition, a voltage status signal can be conveyed through the conductive ring 122, through the thermal switch 104 and thermal sensor element 105, and/or other sensor to the thermal control device 125. Thus, by receiving and processing the signals received from the thermal switching device 103 along the status line 123, the thermal control device 125 can determine that the thermally controlled electrical component 102 is operating under normal thermal conditions.

In the example of FIGS. 1A and 2A, the thermal control device 125 (e.g., BMS) can monitor the temperature condition of the thermally controlled electrical component 102 (e.g., power supply). The thermally controlled electrical component 102 can supply power to the power consumption device 106 (e.g., LOAD L) which can be a motor, an inductor, a transformer, a heater, a housing of an electrical component, for example a semiconductor, or other suitable electrical device. In some implementations, the thermal control device 125 can also be the power consumption device 106 (e.g., LOAD L). In some implementations, the connector 124 can connect to a plurality of (e.g., two) electrical or status lines, and tripping of a thermal switching device 103 can create an open circuit in a plurality of status lines to indicate an overtemperature condition.

A thermal sensor element 105 can be a negative temperature coefficient thermistor (NTC), a positive temperature coefficient thermistor (PTC), a silistor, and/or a thermal temperature sensor (e.g., a resistance temperature detector (RTD)). The thermal sensor element 105 can comprise ceramic, plastic, metal, silicon and/or other semiconductor devices. In some implementations, the thermal sensor element 105 comprises an NTC thermistor. A NTC thermistor is a type of thermistor whose resistance decreases as the temperature of the NTC thermistor increases. The resistance of an NTC thermistor can decrease exponentially as the temperature rises due to the temperature-dependent properties of the material used. As the temperature increases, the number of free charge carriers in the material increases, which leads to a decrease in resistance. NTC thermistors can be used in temperature sensing and compensation applications. For example, NTC thermistors can be used in temperature sensors to measure and monitor temperature changes in various systems. When connected to a circuit, the change in resistance can be converted to an electrical signal proportional to a sensed temperature. In other implementations, the thermal sensor element 105 comprises a PTC thermistor. A PTC thermistor is a type of thermistor whose resistance increases as the temperature increases. Unlike NTC thermistors that have a negative temperature coefficient, PTC thermistors exhibit a positive correlation between resistance and temperature. Under normal operating conditions, the PTC thermistor can have a low resistance which allows current to readily flow through the circuit. However, if an overtemperature and/or overcurrent condition occurs, such as a short circuit, the increased temperature and/or current causes the PTC thermistor to heat up rapidly, which in turn increases its resistance significantly. This high resistance state effectively limits the current flow, which can protect a circuit from damage. Once the fault is removed, the PTC thermistor cools down, and its resistance returns to its low state, allowing normal operation to resume. The PTC thermistor can be used in temperature sensors, motor starting devices, and inrush current limiters for power supplies. The thermal temperature sensor (e.g., RTD) can operate on the principle that the electrical resistance of certain materials changes with temperature. The resistance of the thermal temperature sensor can increase linearly with temperature, which allows for accurate temperature measurements by measuring the resistance and then using a known resistance-temperature relationship.

During operation, therefore, electrical energy from a thermally controlled electrical component 102 (e.g., power supply) can be transferred along the electrically conductive pathway to the thermal switching device 103 with little or no electrical losses. If the temperature of the thermal sensor element 105 is less than the threshold trip temperature, then the thermal switch 104 can remain closed, and the thermal control device 125 receives the normal status signal from the thermal switching device 103 and can determine that the thermally controlled electrical component 102 is operating normally. However, if the temperature of the thermal switching device 103 exceeds the predetermined temperature, then the thermal switch 104 can move to the open condition, interrupting the signal to the thermal control device 125 along the status line 123. The thermal control device 125 can determine that the signal has been interrupted and can indicate to the user and/or a computer program that the thermally controlled electrical component 102 may have experienced an overtemperature condition. Furthermore, after the opening of the thermal switch 104, a determination that the resistance level of the thermal sensor element 105 (e.g., NTC), has exceeded a predetermined threshold trip point can cause the thermal control device 125 to initiate processes to interrupt the circuit between the electrical load L—the power consumption device 106—and the thermally controlled electrical component 102 (e.g., power supply) that is experiencing the overtemperature condition, which may beneficially prevent the temperature from increasing any further to protect the thermally controlled electrical component 102, the power consumption device 106 (e.g., load L) and the larger electrical system 100. In some implementations, for example, the predetermined temperature threshold can be between approximately 55° C. and 77° C. for monitoring and controlling lithium-ion batteries.

For example, in some implementations, the thermal switch 104 can open in response to an increase in temperature of the thermally controlled electrical component 102, which can send a signal to the electronic thermal control device 125 created by a change in resistance, for example, an abrupt increase in resistance. In various implementations, the current along the status line 123 can abruptly be reduced. For example, in some implementations, an analog-to-digital converter (ADC) within the thermal control device 125 can be programmed to calculate a drop or increase in the voltage across the thermal sensor element 105 based on the change in resistance in, for example, the thermistor (e.g., NTC and/or PTC thermistor) or other element in parallel with the thermal switch 104 in which resistance changes with increasing temperature. The thermal control device 125 can be programmed to interpret the change in current and/or resistance as a drop or increase in voltage and, accordingly, as an alert or alarm signal indicating that thermal switching device 103 has exceeded a threshold thermal trip point. In response to the overtemperature alarm, the thermal control device 125 can send instructions that shut down the thermally controlled electrical component 102.

In some implementations, the thermal switch 104 can be configured to be non-resettable, such that, if the thermal switch 104 is flipped or tripped to the open condition from the normally closed condition, the thermal switch 104 remains in the open condition. In such an arrangement, when the thermal switch 104 is opened, the status signal regarding the voltage sent to the thermal control device 125, can be permanently interrupted, and based on that interruption, the thermal control device 125 can determine that the thermally controlled electrical component 102 is in an overtemperature fault condition. In some cases, the user may elect to replace the thermally controlled electrical component 102 that experienced the overtemperature fault condition. In other implementations, the thermal switch 104 can be manually resettable. For example, if the thermal switch 104 is flipped or tripped to the open condition, the thermal control device 125 can indicate to the user that the signal along the status line 123 has been interrupted, which may indicate an overtemperature condition. The user can inspect the power consumption device 106 and if the overtemperature condition is otherwise addressed, the user can reset the thermal switch 104 to the normally closed condition, for example, by pressing a button or engaging another interface. If in a normal condition the thermal switch 104 is in an open position and trips to a closed position, the thermal switch 104 can also be manually reset to the normally open position.

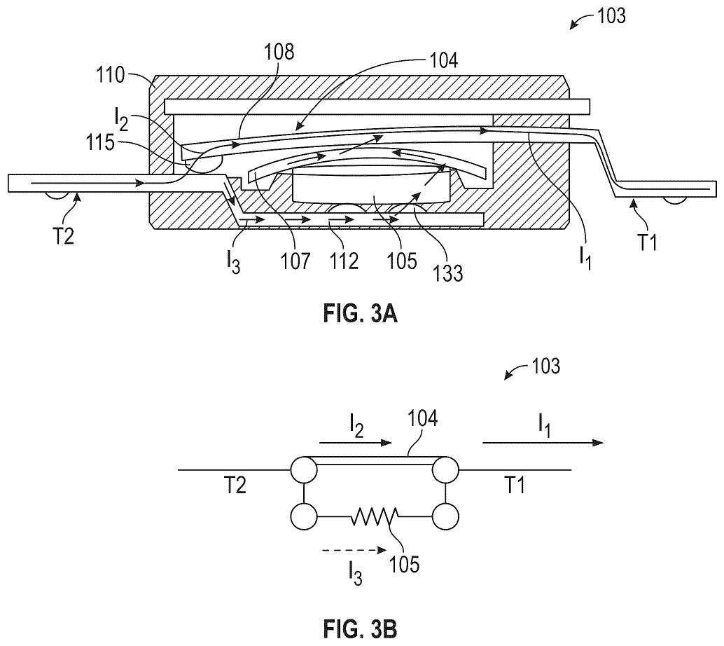

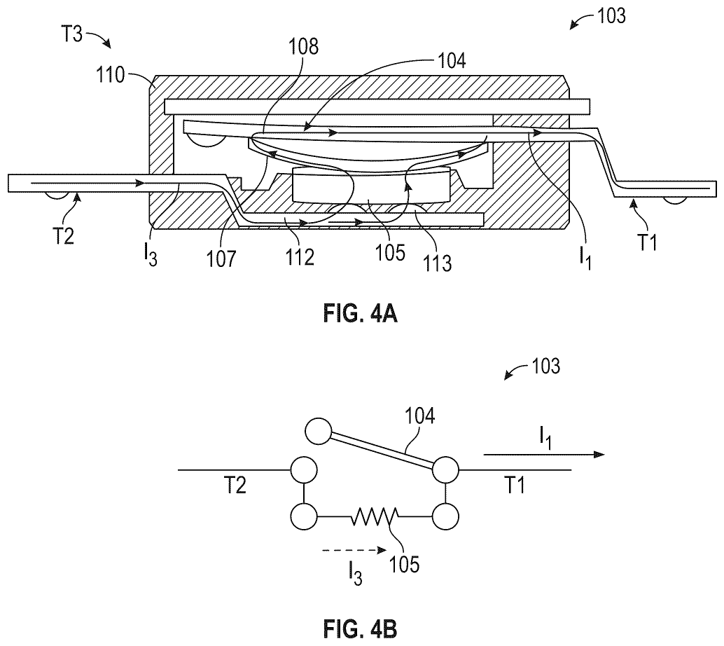

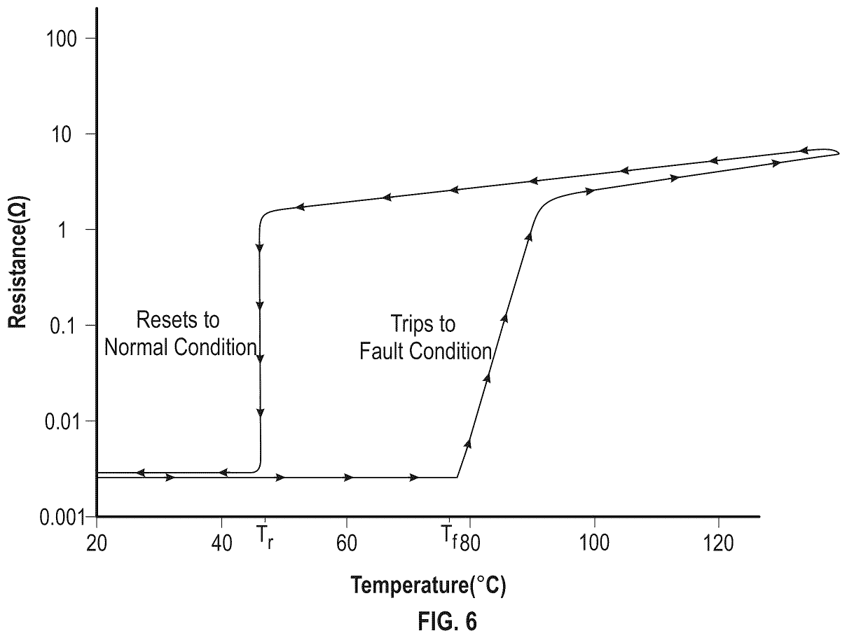

In still other implementations, the thermal switch 104 can be automatically resettable, as explained below in connection with FIGS. 3A-5. In some implementations, as shown in FIGS. 3A-4B, the thermal switch 104 can comprise a bimetal thermal switch element 107 (which may also be referred to herein as a bimetal switch element) in parallel with a positive temperature coefficient (PTC) thermistor, or various combinations of PTCs, thermal cutoffs (TCOs), and/or thermal fuses disposed in parallel or in series. In other implementations, the thermal switch 104 may not include a PTC thermistor. The thermal switch 104 can have hysteresis properties (see, e.g., FIG. 6) that enable the thermal switch 104 to move from the normally closed condition to the open condition when the temperature exceeds a characteristic threshold trip point, and to move back to the normally closed condition from the open condition once the temperature falls below a reset threshold. In such arrangements, the signal from the thermally controlled electrical component 102 along the status line 123 may be intermittently or temporarily interrupted to the thermal control device 125. When the signal is interrupted, the thermal control device 125 (e.g., BMS) can determine that the thermally controlled electrical component 102 is in an overtemperature condition and can indicate the overtemperature condition to the user. If the temperature drops sufficiently, the thermal switch 104 may move back to the normally closed condition, and the voltage signal to the thermal control device 125 can be restored. The thermal control device 125 can accordingly determine that the overtemperature condition has subsided and that the thermally controlled electrical component 102 is operating normally.

Beneficially, the implementation of FIGS. 1A and 2A can provide an accurate determination of whether the temperature of the thermally controlled electrical component 102 is excessive. In the implementations of FIGS. 1A and 2A, the thermal switching device 103 can be integrated with the connector 124 and can be disposed near and/or in close communication with, the thermally controlled electrical component 102. The use of a thermal switching device 103 can beneficially open (and in some implementations close) the thermal switch 104 so as to directly communicate the condition of the thermally controlled electrical component 102 to the thermal control device 125 (e.g., whether or not the thermally controlled electrical component 102 is in a normal operating condition or an overtemperature fault condition). For example, as explained above, the opening of the thermal switching device 103 can send a signal to one or more processors of the processing circuitry of the thermal control device 125 that is caused by a change in resistance (e.g., an abrupt increase/decrease in resistance), which can serve as an alarm representative of an overtemperature condition. The processing circuitry can include circuitry to monitor the thermal sensor element 105. The circuitry, in a normal operating condition, can monitor a status signal of the thermal switching device 103. In the normal operating condition, the signal conveyed to the thermal control device 125 can be a voltage status signal.

In a fault condition in which the thermal switch 104 has tripped to the open position, the circuitry of the thermal control device 125 (e.g., BMS) can determine a temperature of the thermal sensor element 105 and the thermally controlled electrical component 102 based at least on a measured resistance of the thermal sensor element 105 and generate a second status signal. In some implementations, the circuitry can continually monitor the temperature of the thermal sensor element 105 at temperatures above the fault condition in which the thermal switch 104 has tripped to the open position. Circuitry connected to the thermal sensor element 105 and thermal switch 104 can be configured to determine a temperature of the thermally controlled electrical component, thermally controlled electrical component 102 (e.g., a power supply that can include one or more battery cells) based at least in part on the measured voltage across the thermal sensor element 105, which in turn is used to determine the temperature-dependent resistance of the thermal sensor element 105. In some implementations, the circuitry can be part of a separate chip and/or device that can be connected to the thermal control device 125. In some implementations, the circuitry can be formed in or with the thermal control device 125. As mentioned above, the approximate voltage across the thermal switch 104 and/or the thermal sensor element 105 in the thermal switching device 103 can be provided to the thermal control device 125 along the status line 123. In calculating the temperature using the circuitry of the thermal control device 125, the voltage is measured across the thermal switching device 103. The measured voltage is converted into a corresponding resistance value. For example, the corresponding resistance value can be determined from the equation R=V/I, where R is the corresponding resistance value, V is the voltage measured across the thermal switching device 103, and I is the current flowing through the thermal switching device 103. A thermistor can be selected for the thermal switching device 103 at least based on its resistive characteristics for specific applications of the electrical system 100. For example, the thermal sensor, thermal sensor element 105 can be selected to possess resistive characteristics that corresponds to and/or are able to indicate the overtemperature value of a lithium ion battery. The thermal sensor element 105 in this application can accurately measure the temperature of the thermal switching device between at least 55° C. and 77° C. The circuitry can utilize the corresponding resistance value to determine a temperature value. For example, based on a plot (which can be programmed into the circuitry of the thermal control device 125), a temperature value can be identified from the corresponding resistance value. The temperature value can accurately represent the overtemperature value of the thermally controlled electrical component, which could be thermally controlled electrical component 102 or power consumption device 106 (e.g., LOAD L) which could be a motor. Furthermore, the temperature monitoring can beneficially be performed on a high temperature portion of a curve (i.e., after tripping of the thermal switch 104) in which the resistance-temperature can have an approximately linear relationship.

The circuitry can also implement an intervention based at least in part on the generated first and second status signals. The intervention associated with the change in resistance of the tripping to the open configuration of the thermal switching device 103 can generate a momentary digital first thermal alert status signal, which can initiate a warning alarm to be sent to the operator of the electrical system. The circuitry in the thermal control device 125 can be programmed to interpret the temperature of the thermal sensor element 105 (e.g., NTC thermistor) in the thermal switching device 103 reaching a predetermined fault temperature to be that the thermally controlled electrical component 102 has reached the predetermined fault temperature, a continuous, analog second thermal alert status signal. The intervention associated with the determined change in resistance of the thermal sensor element 105 (e.g., NTC thermistor) reaching a predetermined fault temperature can initiate a response by the electronic thermal control device 125 to perform an action. For example, the thermal control device 125 (e.g., BMS) can instruct an action to disconnect the electrical device and/or system 100 from the thermally controlled electrical component 102 (e.g., power source such as a battery cell). Additionally, or alternatively, the intervention associated with the additional change in the resistance of the thermal sensor element 105 to another predetermined fault temperature can initiate additional responses by the thermal control device 125 to perform some other actions, for example, to initiate a call to the fire department.

FIG. 1B is a schematic system diagram of an electrical system 100, according to another implementation. Unless otherwise noted, the components of FIG. 1B may be the same as or generally similar to like-numbered components of FIGS. 1A and 2A. For example, as with the implementation of FIGS. 1A and 2A, a connector 124 can be provided. As with FIG. 2A, the connector 124 can include a thermal switching device 103 as explained above. Unlike the implementation of FIGS. 1A and 2A, instead of connecting to multiple thermally controlled electrical components 102 (e.g., multiple power supplies), in the implementation of FIG. 1B the connector 124 can connect to an individual thermally controlled electrical component 102. The thermal control device 125 (e.g., BMS) and/or power consumption device 106 can electrically connect to the thermally controlled electrical component 102. As shown in FIG. 2A, the status line 123 can provide electrical communication between the connector 124 and the thermal control device 125. As with the implementation of FIGS. 1A and 2A, the implementation of FIG. 1B can similarly monitor a temperature of the thermally controlled electrical component 102 (e.g., battery cell). If the temperature of the thermally controlled electrical component 102 (e.g., battery cell) exceeds a predetermined trip temperature, then the thermal switch 104 can open and the signal to the thermal control device 125 (e.g., BMS) can be interrupted. Moreover, as explained above, the thermal switch 104 can be configured to be non-resettable, manually resettable, or automatically resettable.

In some implementations, as shown in FIG. 2B, the electrical system 100 can further include a thermal sensing device 134 having two or four terminals. The thermal sensing device 134 can including a thermal sensor element 136 (e.g., a negative temperature coefficient thermistor (NTC), a positive temperature coefficient thermistor (PTC), a silistor, and/or a thermal temperature sensor (e.g., a resistance temperature detector (RTD)). The thermal sensor element 136 can be not electrically connected to the thermal switching device 103. The thermal sensing device 134 can include two terminals for conducting current and/or two independent terminals for voltage measurement. A resistance value of the thermal sensor element 136 can be used to calculate an ambient temperature of the connector 124. In some implementations, an average value of a voltage signal across the thermal switching device 103 is used to calculate a DC current (e.g., in Amperes) using a specified resistance as a reference. The thermal sensing device 134 can generate a second status signal along the second status line 138 based at least in part on the determined ambient temperature and implement the intervention based at least in part on the generated second status signal.

FIGS. 3A-6 illustrate various implementations in which the thermal switching device 103 is automatically resettable. As explained above, however, in other implementations, the thermal switching device 103 may be non-resettable or manually resettable. FIG. 3A is a side sectional view of a thermal switching device 103 in a normal operating condition, according to various implementations. FIG. 3B is a schematic circuit diagram of the thermal switching device 103 shown in FIG. 3A. FIG. 4A is a side sectional view of the thermal switching device 103 of FIG. 3A in a fault condition. FIG. 4B is a schematic circuit diagram of the thermal switching device 103 shown in FIG. 4A in a fault condition. The thermal switching device 103 can comprise a thermally activated switch element 104 connected with a thermal sensor element 105 (e.g., positive temperature coefficient (PTC) thermistor). In the implementation of FIGS. 3A-4B, for example, the thermal switch 104 is connected in parallel with the thermal sensor element 105, but in other implementations, the thermal sensor element 105 may be connected in other configurations. In still other implementations, there may be no thermal sensor element 105 (e.g., PTC thermistor) or parallel electrical pathway.

In the illustrated implementations in FIGS. 3A and 4A, the switch element 104 is a thermally activated mechanical switch, in particular a bimetal element. As explained herein, the thermal sensor element 105 (e.g., PTC thermistor) can comprise a resistive element with a resistance that increases with increasing temperature. The thermal sensor element 105 can be any suitable type of PTC thermistor, including a ceramic PTC thermistor or a polymeric PTC thermistor. As shown in FIGS. 3A and 4A, the thermal switching device 103 can comprise an electromechanical device comprising a housing 110 to which a first terminal T1 and a second terminal T2 are coupled. The housing 110 can comprise a first conductive line 112 electrically connected to the second terminal T2 and to a thermal sensor element 105 (e.g., PTC thermistor) by way of one or more interconnects 113.

The thermal switch element 104 can comprise a movable (e.g., pivotable or bendable) and conductive pivotable arm 108 and a bimetal switch element 107. The pivotable arm 108 can electrically connect to the first terminal T1 and to the bimetal switch element 107 by contact. For example, in the normal condition shown in FIG. 3A, the pivotable arm 108 can electrically contact a central portion of the bimetal switch element 107. For example, in FIG. 3A, the pivotable arm 108 is shown in a normal condition in which a contact 115 on a distal end portion of the pivotable arm 8 contacts and is electrically connected to the first conductive line 112 and the second terminal T2. In FIG. 4A, the pivotable arm 108 is shown in a fault condition in which the pivotable arm 108 is disconnected from the second terminal T2 and in an open electrical configuration. In the fault condition, the pivotable arm 108 can also electrically contact the bimetal switch element 107 at opposing end portions of the bimetal switch element 107.

The pivotable arm 108 can move from the normal condition to the fault condition by engaging with the bimetal switch element 107 and the thermal sensor element 105 (e.g., PTC thermistor). For example, the bimetal switch element 107 can comprise an electromechanical or thermomechanical switch element, particularly a dome-shaped bimetal element, such as a disc having different metals on different sides, which changes shape in response to temperature changes. During normal operation, as shown in FIGS. 3A and 3B, a first current I₁ can flow along the pivotable arm 108. Most of the current I₂ passes through the second terminal T2, the first conductive line 112, and the pivotable arm 108 without passing through the thermal sensor element 105 (e.g., PTC thermistor). However, a small trickle current I₃ (shown in dashed lines in FIG. 3B) passes from the second terminal T2 and the first conductive line 112 to the pivotable arm 108 through the thermal sensor element 105 (e.g., PTC thermistor) and the bimetal switch element 107. As explained above, during normal operation, the current I₂ that bypasses the thermal sensor element 105 (e.g., PTC thermistor) may be much greater than the trickle current I₃ through the thermal sensor element 105 (e.g., PTC thermistor).

If the temperature and/or current through the thermal switching device 103 exceeds the trip temperature, then the thermal switching device 103 can move from the normal operating position shown in FIGS. 3A-3B to the fault position shown in FIGS. 4A-4B. For example, if the temperature of the bimetal switch element 107 exceeds a particular trip temperature, which can be selected and tuned in the manufacturing process, such as by material, processing and dimensional choices, then the bimetal switch element 107 can switch from the downwardly-curving shape of FIG. 3A to the upwardly-curving shape of FIG. 4A. The thermal sensor element 105 (e.g., PTC thermistor) can also increase the temperature of the bimetal switch element 107, as increasing currents through the thermal sensor element 105 (e.g., PTC thermistor) cause increases in temperature of the thermal sensor element 105 (e.g., PTC thermistor) and the bimetal switch element 107, which contacts the thermal sensor element 105 (e.g., PTC thermistor). The correspondence between resistance and temperature may be non-linear as shown (e.g., in FIG. 6) in which at a threshold or trip temperature (or range of temperatures) the resistance may increase significantly so as to cause a greater rate of temperature increase. When the bimetal switch element 107 changes shape to the upwardly-curving shape shown in FIG. 4A, the bimetal switch element 107 can move the pivotable arm 108 to an open configuration. Although the bimetal switch element 107 is shown as downwardly-curving in the normal condition and upwardly-curving in the fault condition, it should be appreciated that in other arrangements the thermal switching device may also be configured such that the bimetal switch element 107 is in an upwardly-curving shape during normal operating conditions and in a downwardly-curving shape during a fault condition.

During a fault configuration, the increased temperature of the thermal sensor element 105 (e.g., PTC thermistor) accordingly increases the resistance and decreases the current flow through the thermal switching device 103. As explained in additional detail below with respect to FIG. 6, a trickle current I₃ can provide a small amount of current from the battery pack or cell to enable essential device functionality, because the heat generated by the thermal sensor element 105 (e.g., PTC thermistor) maintains high temperatures after the initial fault condition to prevent the thermal switch 104 from chattering or dithering (i.e., from repeatedly switching between the fault mode and the normal operating mode). Thus, in some implementations, if chattering or dithering is problematic for the switching element, then the thermal sensor element 105 (e.g., PTC thermistor) may be used. In other implementations, the material, processing, and/or design of the bimetal switch element 107 and the pivotable arm 108 can result in the reset temperature being significantly lower than the trip temperature, eliminating the chatter or dither problems, and the thermal sensor element 105 (e.g., PTC thermistor) may be omitted (e.g., the design of the bimetallic disc and the pivotable arm can be adjusted so as to obviate the use of a thermal sensor element 105 (e.g., PTC thermistor)). The skilled artisan will appreciate that the trickle currents I₃ through the thermal sensor element 105 (e.g., PTC thermistor) can have different magnitudes under normal and fault conditions, and that the magnitude of I₃ can change during the advent of a fault condition. In some implementations, the thermal sensor element 105 (e.g., PTC thermistor) may be replaced by a different thermal sensor element, for example a ceramic NTC thermistor, or a silicon silistor or other thermal sensor element.

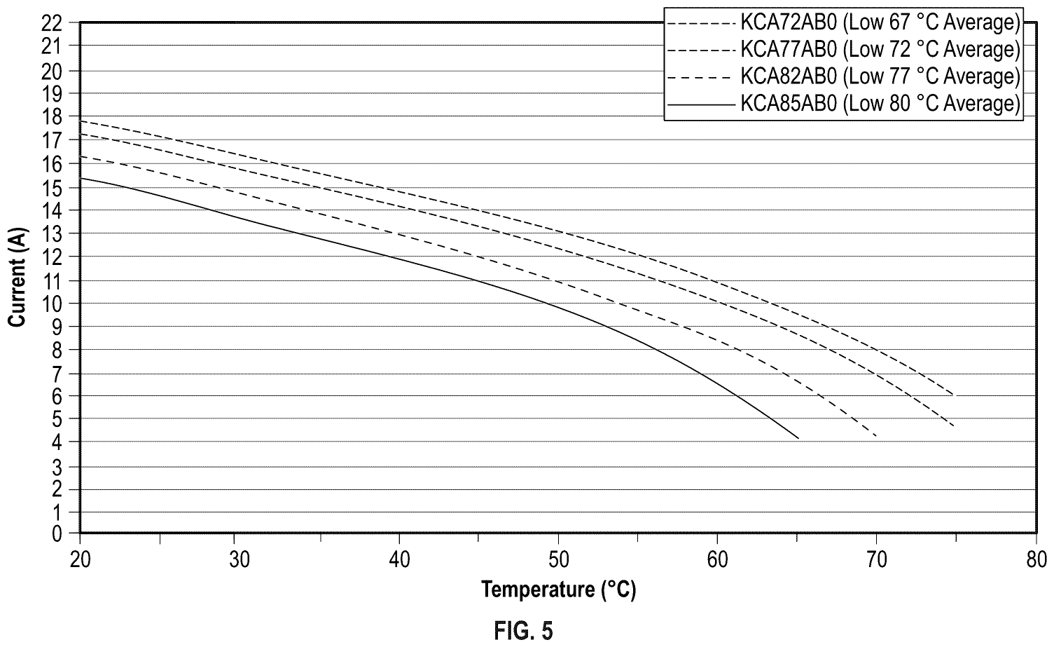

FIG. 5 is a graph that shows the current and temperature at which exemplary thermal switches 104 trip from a normal operating condition to a fault condition, according to various implementations. In particular, FIG. 5 is a plot of current versus temperature for dome-shaped bimetal switches used in Bourns™ and Komatsulite™ KCA Series A-Type Breakers, commercially available from Bourns, Inc., of Riverside, California. In particular, FIG. 5 plots the current versus temperature for four different versions of the Series A-Type Breakers. In FIG. 5, the line represents the temperature and current combination at which the particular breaker trips to the fault condition. Thus, the region below each line indicates a normal condition and the region at the line and above indicates a fault condition. As shown in FIG. 5, the thermally activated switch element 104 can trip from the normal operating condition to the fault condition at relatively high temperatures (even at low currents) and/or at relatively high currents (even at low temperatures). For example, the thermally activated switch element 104 can trip from the normal operating condition to the fault condition when the thermally activated switch element 104 reaches a preset threshold or trip temperature in a range of 65° C. to 85° C., or more particularly, in a range of 70° C. to 80° C., depending upon the design.

The use of the thermal sensor element 105 (e.g., PTC thermistor) can provide various advantages in some implementations. As explained herein, the thermal sensor element 105 (e.g., PTC thermistor) can enable the thermally activated switch element 104 and thermal switching device 103 to operate in a stable manner, such that the thermal switching device 103 does not chatter and/or dither at various rates between the normal condition and the fault condition by maintaining an elevated temperature after an initial fault condition. Instead, due to hysteresis behavior, a significant reduction in the temperature of the thermal switching device 103 is required before the self-resetting of the thermal switching device 103 from the fault condition to the normal operating condition under some circumstances.

FIG. 6 is a schematic graph that shows the relationship between temperature and resistance of an exemplary thermal sensor element 105 (e.g., PTC thermistor), according to various implementations. For example, as shown in FIG. 6, at temperatures below a predetermined fault temperature T_{f}, the resistance R_{PTC} of the thermal sensor element 105 (e.g., PTC thermistor) can be at a relatively low level (but can be higher than the resistance R_{S} of the thermal switch 104). As the temperature of the thermal sensor element 105 (e.g., PTC thermistor) reaches the predetermined fault temperature T_{f}, the resistance R_{PTC} can increase significantly with increasing temperature. In the thermal switching device 103 of FIGS. 3A-4B, the increasing temperature of the thermal sensor element 105 (e.g., PTC thermistor) can further increase the temperature of the bimetal switch element 107 that contacts the thermal sensor element 105 (e.g., PTC thermistor). Thus, the increasing temperature of the thermal sensor element 105 (e.g., PTC thermistor) can accelerate or otherwise assist in causing the bimetal switch element 107 to change shape and trip to the fault condition shown in FIGS. 4A-4B, providing a faster reaction time for a thermomechanical switch.

Advantageously, the hysteresis shown in FIG. 6 can prevent the thermal switching device 103 from operating in a chatter and/or dither mode. In a chatter and/or dither mode, without the hysteresis shown in FIG. 6, as the temperature decreases (even slightly), the temperature of the bimetal switch element 107 would decrease and switch back into the normal operating condition prematurely. The increasing current of the operating condition would again increase the temperature of the bimetal switch element 107 past the fault temperature T_{f}, and the breaker might repeatedly switch from normal operating condition to fault condition, and back again. Such a chattering and/or dithering mode is undesirable and can lead to instability in the larger electrical system or device 100.

Thus, the thermal switching device 103 of FIGS. 3A-4B can advantageously employ a thermal sensor element 105 (e.g., PTC thermistor) connected with the thermal switch 104 (for example, in parallel) to maintain stable operating and fault conditions. The thermal switching device 103 of FIGS. 4A-5B can advantageously be self-resettable in some arrangements, such that the thermal switching device 103 (e.g., breaker) can return to the normal operating condition if the fault condition subsides (for example, by a sufficient decrease in current and/or temperature). Furthermore, as explained herein, the thermal switching device 103 can stably move to the fault condition and back to the normal operating condition without chattering and/or dithering.

In other implementations, as explained above, the thermal switching device 103 can be manually resettable or not resettable at all. In such implementations, for example, there may be no PTC thermistor in the thermal switching device 103 and no electrical pathway in parallel with the thermally activated switch element 104. In such arrangements, if the thermal switch 104 trips in a fault condition, then the switch 4 may remain permanently in the open configuration to prevent current from flowing to and from the thermal control device 125. In some implementations, the thermal switching device 103 can comprise a button or other manual user interface to enable the user to manually reset the thermal switching device 103 into the normal operating configuration. Still other arrangements for the thermal switching device 103 may be suitable.

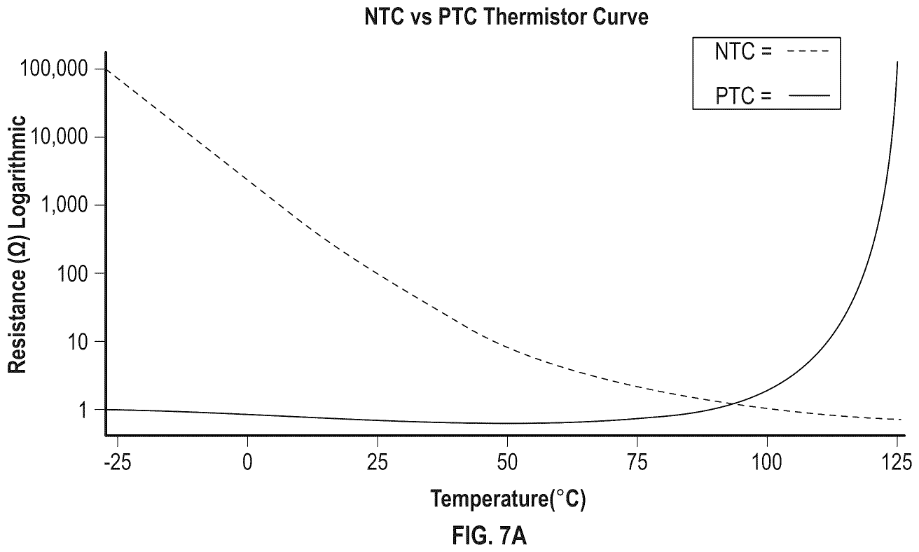

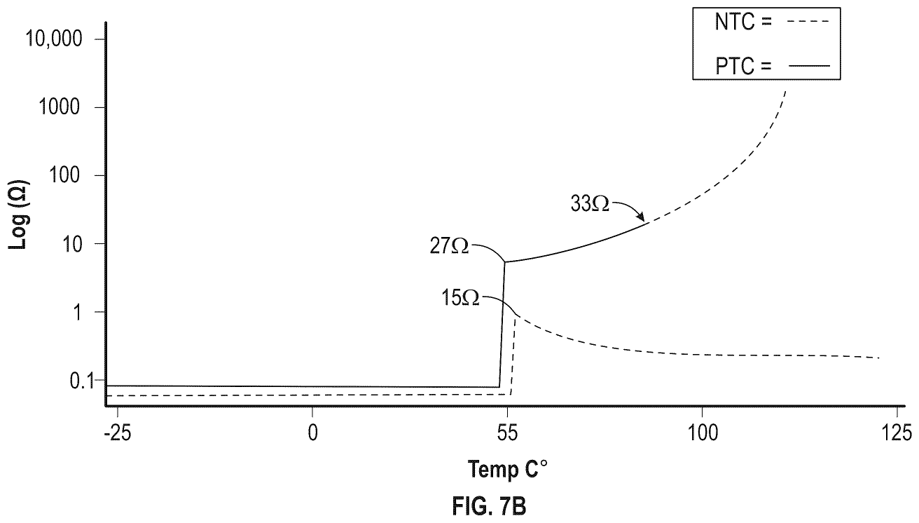

FIG. 7A is a graph illustrating the temperature vs. logarithmic resistance curve for an exemplary NTC thermistor and an exemplary PTC thermistor. As demonstrated in FIG. 7A, NTC thermistors act in an opposite fashion as PCT thermistor. As previously mentioned, and illustrated in FIG. 7A, as temperature increase the resistance value of the NTC thermistor decreases. Conversely, as temperature increases the resistance value of the PTC thermistor increases.

FIG. 7B is a graph illustrating the temperature vs. resistance (logarithmic) curve for two different thermal switching devices 103, one with an exemplary PTC thermistor and one with an exemplary NTC thermistor. As show in FIG. 7B, when the temperature is less than approximately 55° C., the resistance of the thermal switching devices 103 with the PTC thermistor and the other with the NTC thermistor is less than 0.06 ohms, because most of the current is flowing through the thermally actuated switch, 104 until the thermal switching devices 103 reach the predetermined trip temperature of 55° C. When the temperature of the thermal switching device 103 with the PTC thermistor reaches the preset trip temperature of 55° C., the resistance of the thermal switching devices 103 with the PTC thermistor jumps exponentially from 0.06 ohms to 27 ohms, then quickly reaches 33 ohms. When the temperature of the thermal switching device 103 with the NTC thermistor reaches the preset trip temperature of 55° C., the resistance of the thermal switching devices 103 with the NTC thermistor jumps exponentially from about 0.06 ohms to about 15 ohms, then slowly drops to about 0.1 ohms the temperature increases. As temperature increases, the resistance of the NTC thermistor decreases approximately linearly.

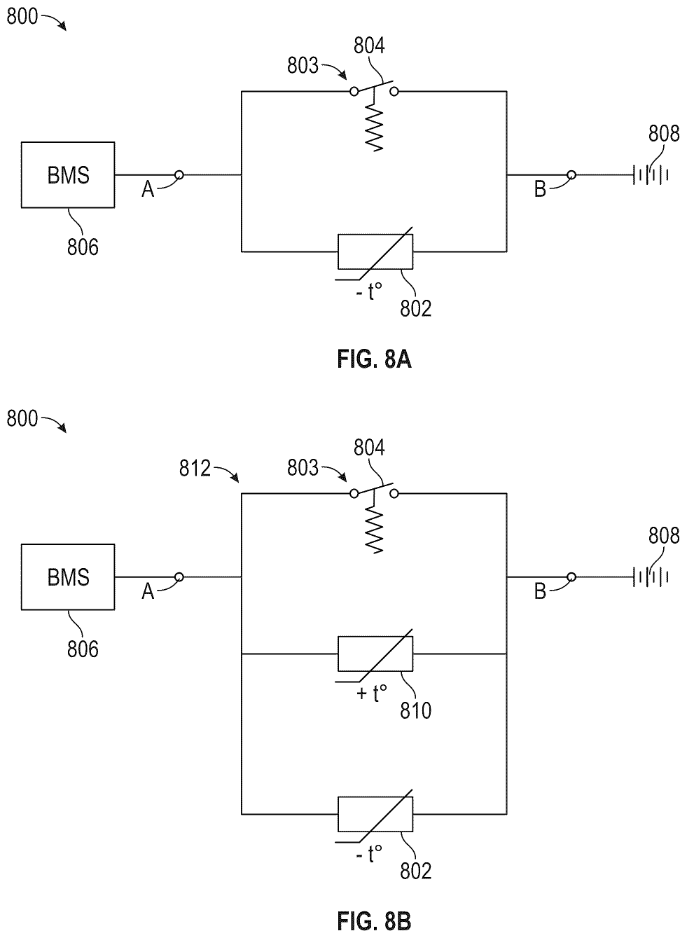

FIGS. 8A and 8B illustrate example schematic diagrams having a thermal switching device 803 for an electrical system 800. FIG. 8A is a schematic diagram of a portion of an electrical system 800, according to various implementations. In FIG. 8A, the electrical system 800 can include thermal switching device 803 having a thermal sensor element 802 (e.g., a thermistor) and a thermally activated switch 804 (including a bimetallic switching element) in parallel with the thermal sensor element 802. The thermal sensor element 802 can act as a temperature sensor element. The thermal switch 804 can be generally similar to and/or identical to thermal switch 104 described herein. If the thermal switch 804 is in an open position, current can flow through the thermal sensor element 802 until the thermal sensor element 802 heats up to the thermal switch 804 threshold temperature causing the thermal switch 804 to trip to a closed position. The thermal sensor element 802 and thermal switch 804 can be electrically connected to an electronic control device 806 (e.g., BMS, etc.) at a first terminal (i.e., Terminal A) and a thermally controlled electrical component 808 (e.g., battery cell, etc.) at a second terminal (i.e., Terminal B). The thermal sensor element 802 can include negative temperature coefficient (NTC) thermistor. For example, the thermal sensor element 802 can be a NTC thermistor as shown in FIG. 8A. When the thermal switch 804 of the thermal switching device 803 is in an open configuration, a reading of the voltage and current can be taken across the thermal switching device 803 (e.g., between terminals A and B), particularly, the thermal sensor element 802, to determine the resistance of thermal sensor element 802 by the electronic control device 806 which can prompt a pre-programmed response.

FIG. 8B is another schematic diagram of a portion of an electrical system 800, according to another implementation. In FIG. 8B, the electrical system 800 can include thermal switching device 803 having a thermal sensor element 802, a thermal switch 804, and a second thermal sensor element 810. The second thermal sensor element 810 can include a PTC thermistor or negative temperature coefficient (NTC) thermistor. As shown in FIG. 8B, the second thermal sensor element 810 can be a PTC thermistors to heat the thermal switch 804. As mentioned above, the thermal sensor element 802 can continue to act as a temperature sensor element. The second thermal sensor element 810 and switch 804 form a breaker 812. In various implementations, exemplary breakers and their described function is disclosed at least in Japanese Patent Nos. JP5976336B2 and pending Japanese Application No. JP2018060746A and JP2020532395A of Bourns KK, the entire contents of each of which are incorporated by reference herein in their entirety and for all purposes. The breaker 812 and the thermal sensor element 802 can be connected in parallel. The breaker 812 and thermal sensor element 802 can be electrically and thermally connected to each other. When the switch 804 of the breaker 812 is open, current can flow through the thermal sensor element 802 and the second thermal sensor element 810. As current passes through the second thermal sensor element 810 (e.g., thermistor such as a PTC and/or NTC thermistor), the second thermal sensor element 810 can generate heat due to its resistive properties to cause the thermal switch 804 to trip to an open configuration when the temperature exceeds a characteristic threshold (i.e., the switch 804 is maintained in an open position when the current through second thermal sensor element 810 exceeds a threshold temperature), and to move back to the normally closed position from the open position once the temperature falls below a reset threshold. In the open position, current flowing through the electrical system 800 can pass through the thermal sensor element 802 and second thermal sensor element 810. Thus, when the breaker 812 trips (i.e., the thermal switch 804 switches from the closed position to an open position), the current passes through the thermal sensor element 802 as the current does not flow (or only flows as a trickle) through the breaker 812 due to the resistive properties of the second thermal sensor element 810 and the open switch 804. Current passing through the second thermal sensor element 810 can maintain the heat generation until the current is turned off, allowing the second thermal sensor element 810 to cool off.

A potential issue that can arise is that the second thermal sensor element 810 (e.g., PTC thermistor) can complicate and/or interfere with the voltage reading across the thermal sensor element 802 (e.g., NTC thermistor). An example to solve the complication and/or interference is to include an insulating layer between the thermal sensor element 802 and the second thermal sensor element 810 to prevent heat transfer from the second thermal sensor element 810 to the thermal sensor element 802. Similar to the electrical system 800 of FIG. 8A, a resistance value of the thermal sensor element 802 can be determined by measuring the voltage on both sides of the thermal sensor element 802 and/or the thermal switching device 803. The resistance value can be utilized by the thermal control device 125 to calculate the temperature of the thermal sensor element 802 and generate a signal from the electronic control device 806. The signal can prompt a response from the electronic control device 806 and/or another electronic device.

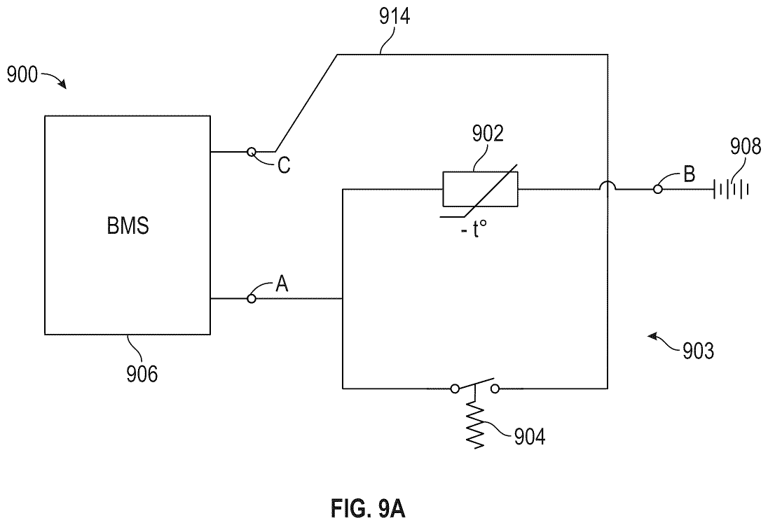

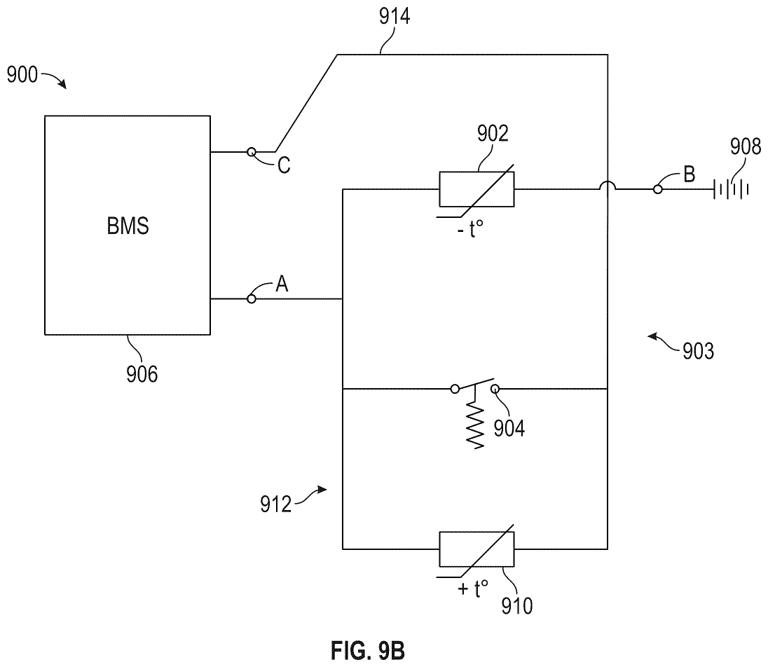

FIGS. 9A and 9B illustrate example schematic diagrams having a thermal switching device 903 for electrical system 900, according to some implementations. FIG. 9A is a schematic diagram of a portion of an electrical system 900, according to various implementations. In FIG. 9A, the electrical system 900 can include a thermal switching device 903 having thermal switch 904, a thermal sensor element 902, and an electronic control device 906 (e.g. a BMS), and a thermally controlled electrical component 908 (e.g. power supplying device such as a battery cell) which can be similar or identical to those found in FIGS. 8A-8B. However, the electrical system 900 of FIG. 9A can include a three-terminal variation of the electrical system of FIG. 8A that can measure the voltage drop across the thermal sensor element 902 (e.g., NTC thermistor) by the electronic control device 906.

The electrical system 900 can further include a voltage sense wire 914 connecting to the electronic control device 906 at a third terminal (i.e., Terminal C). The voltage sense wire 914 can be a wire and/or conductor for measuring voltage. For example, the voltage sense wire 914 can measure voltage drops and/or voltage variations due to resistance, impedance, and/or other factors. The voltage sense wire 914 can have low resistance to minimize any additional voltage drops and/or interference that could affect the voltage measurement. The voltage sensing wire 914 can be used to measure the voltage at one or more locations along the electrical system 900 relative to ground. The voltage sense wire 914 can measure the voltage drop through the thermal sensor element 902 independent of whether the thermal switch 904 is open or closed. In some implementations, the electrical system 900 can include a plurality of voltage sense wires 914 connected to multiple batteries and/or power consumption devices. Additionally, or alternatively, when the thermal switch 904 of the thermal switching device 903 is in an open position, a reading of the voltage and current can be taken across the thermal switching device 903 (e.g., between terminals A and B), particularly, the thermal sensor element 902, to determine the resistance of thermal sensor element 902 by the electronic control device 906. As mentioned above, the measured voltage through the Terminals A and B or Terminals C and B can be used to determine the corresponding resistance value of the thermal sensor element 902. The corresponding resistance value can be utilized by the electronic control device 906 to calculate the temperature of the thermal sensor element 902 and generate a signal. The signal can prompt a response from the electronic control device 906 and/or another electrical device. According to some implementations, the electrical system 900 can provide accurate readings connected to a power consuming device or load such as a motor.

FIG. 9B is another schematic diagram of a portion of an electrical system 900, according to various implementations. In FIG. 9B, the electrical system 900 can be similar and/or identical to the electrical system 900 of FIG. 9A except that the thermal switching device 903 of FIG. 9B can include a second thermal sensor element 910 connected in parallel with the thermal switch 904. The second thermal sensor element 910 and thermal switch 904 can form a breaker 912, which can operate similarly and/or identically to the breaker 812. The breaker 912 and the thermal sensor element 902 can be connected in parallel. A third terminal (i.e., Terminal C), allows for measurement of voltage drop across the thermal sensor element 902 by the electronic control device 906. The breaker 912 and thermal sensor element 902 can be electrically and thermally connected. When the thermal switch 904 opens, current can flow through the thermal sensor element 902 and the second thermal sensor element 910. An insulating layer can be disposed between the thermal sensor element 902 and the second thermal sensor element 910 to prevent heat transfer. The electrical system 900 can further include a voltage sense wire 914 connecting to the electronic device 906 at a third terminal (i.e., Terminal C). The voltage sense wire 914 can be a wire and/or conductor for measuring voltage. For example, the voltage sense wire 914 can measure voltage drops and/or voltage variations due to resistance, impedance, and/or other factors. The voltage sense wire 914 can have low resistance to minimize any additional voltage drops and/or interference that could affect the voltage measurement. The voltage sense wire 914 can measure the voltage drop through the thermal sensor element 902 independent of whether the thermal switch 904 is open or closed. In some implementations, the electrical system 900 can include a plurality of voltage sense wires 914 connected to multiple batteries and/or power consumption devices. According to some implementations, the electrical system 900 can provide accurate readings connected to a power consuming device such as a power consuming device or load such as a motor.

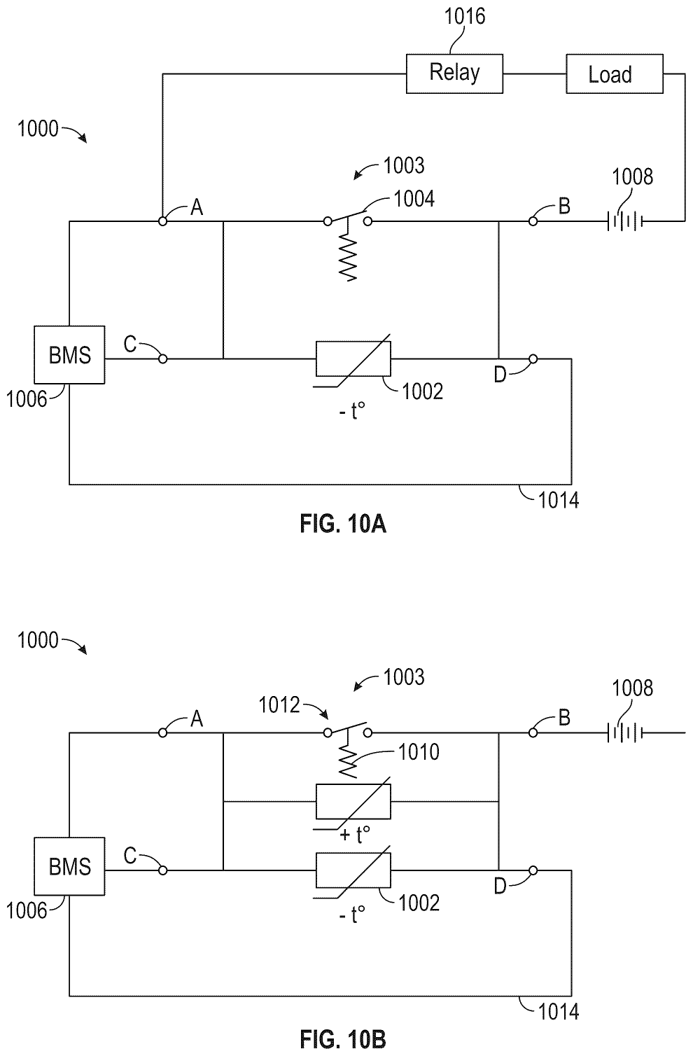

FIGS. 10A and 10B illustrate example schematic diagrams having a thermal switching device 1003 for an electrical system 1000, according to some implementations. FIG. 10A is a schematic diagram of a portion of the electrical system 1000 having a thermal switching device 1003, according to various implementations. In FIG. 10A, the electrical system 1000 can include a thermal switching device 1003 having a thermal switch 1004 and a thermal sensor element 1002, an electronic control device 1006 (e.g. a BMS) and a thermally controlled electrical component 1008 (e.g., power supplying device) which can be similar or identical to those found in FIGS. 8A-9B. However, the electrical system 1000 can include a four-terminal variation of the electrical systems of FIGS. 8A-9B. A first pair of terminals (e.g., Terminals A and B) can be current in and current out terminals (e.g., during charging), respectively. The current in terminal A can be the input terminal through which electrical current is supplied to a device and/or circuit. The current in terminal A can be connected to a power source and/or another circuit that provides the required current. The current out terminal B can be the output terminal from which electrical current is delivered or extracted from a device and/or circuit. The current out terminal B can be the point where the current exits the device and/or circuit and can be connected to a load and/or another circuit that utilizes the current. A second pair of terminals (e.g., Terminals C (vₛₑₙₛₑ₊) and D (vₛₑₙₛₑ₋)) can be voltage sense terminals to directly measure the voltage without being affected by any voltage drops and/or variations along the connecting wires. Terminals C and D can monitor a voltage across the thermal sensor element 1002. In some implementations, the electrical system 1000 can include a relay 1016 connected to the first terminal (e.g., Terminal A) and to the thermally controlled electrical component 1008. The relay 1016 can include a power consumption device 1008 (e.g., Load L). The power consumption device 10010088 can be similar and/or identical to power consumption device 106. During charging of the electrical system 1000, current can be flowing into Terminal A and out of Terminal B. During discharging of the electrical system 1000, current can flow out of Terminal A and into Terminal B.

The electrical system 1000 can further include a voltage sense wire 1014 connecting to the electronic control device 1006 to the negative voltage sense terminal. The voltage sense wire 1014 can be a wire and/or conductor for measuring voltage. The voltage sense wire 1014 can measure the voltage drop through the thermal sensor element 1002 independent of whether the thermal switch 1004 is open or closed. In some implementations, the voltage sense wire 1014 can be a Kelvin sensing line, also known as four-terminal sensing, to measure the voltage and/or current through the thermal sensor element 1002. Kelvin sensing is an electrical impedance measuring technique that uses separate pairs of current-carrying and voltage-sensing electrodes to make more accurate measurements. Two 90-degree paths from Terminals C and D can be used for Kelvin sensing for accurate reading of the of the voltage through the thermal sensor element 1002 since the voltage sense wire 1014 is not drawing current from path between the electronic control device 1006 to the thermal sensor element 1002 and from the thermal sensor element 1002 to the thermally controlled electrical component 1008. In some implementations, the electrical system 1000 can include a plurality of voltage sense wires 1014 connected to multiple batteries and/or power consumption devices. According to some implementations, the current terminals, Terminals A and B, can be electrically in common with voltage sensing terminals, Terminals C and D. A voltmeter can be connected to the Terminals C and D to measure the voltage. The voltmeter can calculate the current flowing and the voltage flowing in and out of the terminals. According to some implementations, Terminals A and B can be used for conducting high current.

When the thermal switch 1004 of the thermal switching device 1003 is in an open position, a reading of the voltage and current can be taken across the thermal switching device 1003, particularly, the thermal sensor element 1002, to determine the resistance of thermal sensor element 1002 by the electronic control device 1006. The corresponding resistance value can be utilized by the electronic control device 1006 to calculate the temperature of the thermal sensor element 1002 and generate a signal. The signal can prompt a response from the electronic control device 1006 and/or another electrical device. According to some implementations, the electrical system 1000 can provide accurate readings connected to a power consuming device or load such as a motor.

FIG. 10B is another schematic diagram of a portion of an electrical system 1000, according to various implementations. In FIG. 10B, the electrical system 1000 can be similar and/or identical to the electrical system 1000 of FIG. 10A except that the electrical system 1000 can include a second thermal sensor element 1010. The second thermal sensor element 1010 and thermal switch 1004 can form a breaker 1012, which can operate similarly and/or identical to the breakers 812, 912. The breaker 1012 and the thermal sensor element 1002 can be connected in parallel with the thermal switch 1004. When the thermal switch 1004 of the breaker 1012 is open, current can flow through the thermal sensor element 1002 and the second thermal sensor element 1010. Similar to the second thermal sensor element 810 and the second thermal sensor element 910, as current passes through the second thermal sensor element 1010, the second thermal sensor element 1010 can generate heat due to its resistive properties to cause the thermal switch 1004 to trip to an open configuration when the temperature exceeds a characteristic threshold, and to move back to the normally closed condition from the open condition once the temperature falls below a reset threshold. In the open configuration, current flowing through the electrical system 1000 can pass through the thermal sensor element 1002 and second thermal sensor element 1010. Current passing through the second thermal sensor element 1010 can maintain the heat generation until the current is turned off, allowing the second thermal sensor element 1010 to cool off.

The electrical system 1000 of FIG. 10B can also include a first pair of terminals (e.g., Terminals A and B) can be current in and current out Terminals, respectively. The current in Terminal A can be the input terminal through which electrical current is supplied to a device and/or circuit. The current in Terminal A can be connected to a power source and/or another circuit that provides the required current. The current out Terminal B can be the output terminal from which electrical current is delivered or extracted from a device and/or circuit. The current out Terminal B can be the point where the current exits the device and/or circuit and can be connected to a load and/or another circuit that utilizes the current. The naming convention of current in for Terminal A and current out for Terminal B can apply when electrical system 1000 is in a charging condition and can be reversed to current out for Terminal A and current in for Terminal B when electrical system 1000 is in a discharging condition. A second pair of terminals (e.g., Terminals C and D) can be voltage sense terminals to directly measure the voltage without being affected by any voltage drops and/or variations along the connecting wires. Terminals C and D can monitor a voltage across the thermal sensor element 1002. In some implementations, the electrical system 1000 can include a relay not shown connected to the first terminal (e.g., Terminal A) and to the thermally controlled electrical component 1008 described in FIG. 10A. The relay can include a power consumption device (e.g., Load L). The power consumption device can be similar and/or identical to power consumption device 106. During charging of the electrical system 1000, current can be flowing into Terminal A and out of Terminal B. During discharging of the electrical system 1000, current can flow out of Terminal A and into Terminal B.

The electrical system 1000 can further include a voltage sense wire 1014 connecting to the electronic control device 1006 to the negative voltage sense terminal. The voltage sense wire 1014 can be a wire and/or conductor for measuring voltage. The voltage sense wire 1014 can measure the voltage drop through the thermal sensor element 1002 independent of whether the thermal switch 1004 is open or close. In some implementations, the electrical system 1000 can include a plurality of voltage sense wires 1014 connected to multiple batteries and/or power consumption devices. According to some implementations, the electrical system 1000 can provide accurate readings connected to a power consuming device such as a motor. According to some implementations, the current terminals, Terminals A and B, can be electrically in common with voltage sensing terminals, Terminals C and D. A voltmeter can be connected to the Terminals C and D to measure the voltage. The voltmeter can calculate the current flowing and the voltage flowing in and out of the terminals. According to some implementations, Terminals A and B can be used for conducting high current. When the thermal switch 1004 of the thermal switching device 1003 is in an open configuration, a reading of the voltage and current can be taken across the thermal switching device 1003, for example, the thermal sensor element 1002, to determine the resistance of thermal sensor element 1002 by the electronic control device 1006. The corresponding resistance value can be utilized by the electronic control device 1006 to calculate the temperature of the thermal sensor element 1002 and generate a signal. The signal can prompt a response from the electronic control device 1006 and/or another electrical device. According to some implementations, the electrical system 1000 can provide accurate readings connected to a power consuming device or load such as a motor.

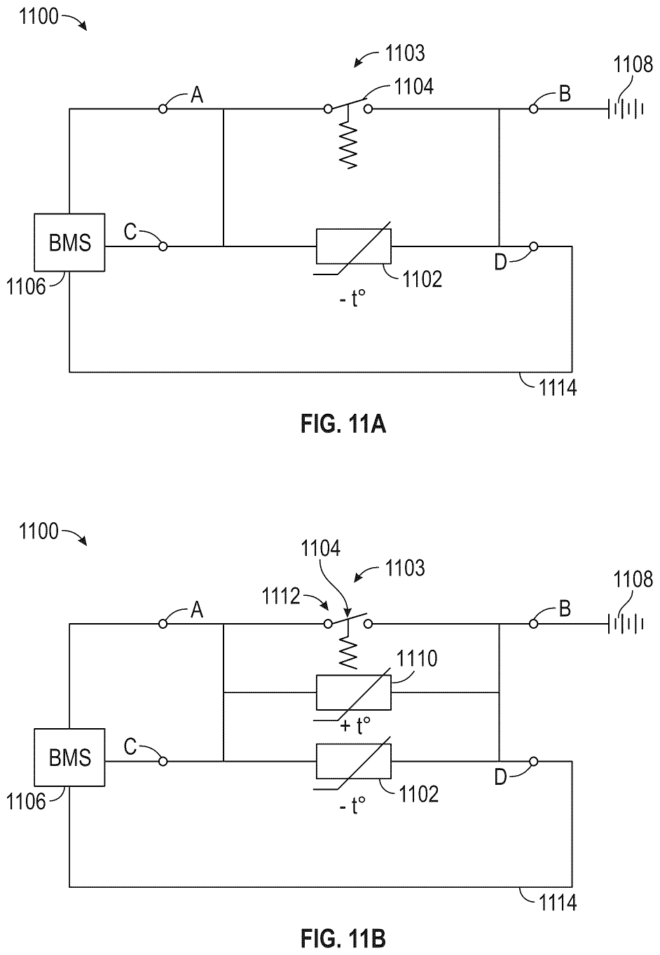

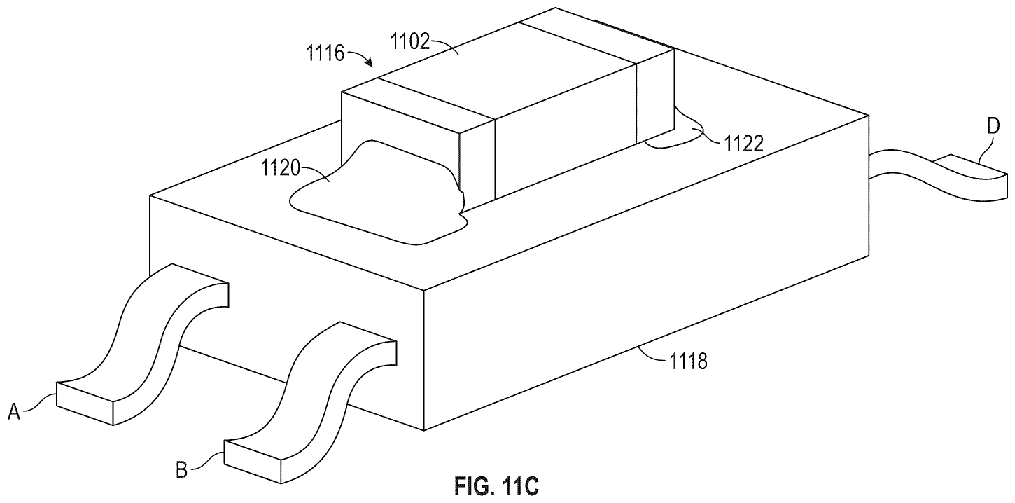

FIGS. 11A and 11B illustrate example schematic diagrams having a thermal switching device 1103 device for electrical system 1100, according to some implementations. FIG. 11A is a schematic diagram of a portion of an electrical system 1100, according to various implementations. The electrical system 1100 can be similar or identical to the electrical system 1000 except that the thermal sensor element 1102 can be an externally mounted discrete device 1116 as shown in FIG. 11C. The externally mounted discrete device 1116 housing the thermal sensor element 1102 can be electrically and mechanically mounted to pads (not shown) on a surface of the device 1118 such that a positive terminal 1120 and a negative terminal 1122 of the device 1116 is connected to the Terminals A, B (not shown in FIG. 11C), C, and/or D. The Terminals C (vₛₑₙₛₑ₊) and D (vₛₑₙₛₑ₋) can be smaller than the Terminals A and B since Terminals C and D can be voltage sensing terminals. As mentioned above, Terminals A and B can be current in and current out Terminals, respectively. When the thermal switch 1104 of the thermal switching device 1103 is in an open configuration, a reading of the voltage and current can be taken across the thermal switching device 1103, particularly, the thermal sensor element 1102, to determine the resistance of thermal sensor element 1102 by the electronic control device 1106. The corresponding resistance value can be utilized by the electronic control device 1106 to calculate the temperature of the thermal sensor element 1102 and generate a signal. The signal can prompt a response from the electronic control device 1006 and/or another electrical device. According to some implementations, the electrical system 1100 can provide accurate readings connected to a power consuming device or load such as a motor. The electrical system 1100 can further include a voltage sense wire 1114 connecting to the electronic control device 1106 to the negative voltage sense terminal.

In some implementations, the electrical system 1100 can include a relay not shown connected to the first terminal (e.g., Terminal A) and to the thermally controlled electrical component 1108 described in FIG. 10A. The relay can include a power consumption device (e.g., Load L). The power consumption device can be similar and/or identical to power consumption device 106. During charging of the electrical system 1100, current can be flowing into Terminal A and out of Terminal B. During discharging of the electrical system 1100, current can flow out of Terminal A and into Terminal B.

FIG. 11B is another schematic diagram of a portion of an electrical system 1100, according to various implementations. In FIG. 11B, the electrical system 1100 can be similar and/or identical to the electrical system 1100 except that the electrical system 1100 of FIG. 11B can include a second thermal sensor element 1110. The second thermal sensor element 1110 and thermal switch 1104 can form a breaker 1112, which can be similar and/or identical to the breakers 812, 912, 1012. The breaker 1112 and the thermal sensor element 1102 can be connected in parallel. When the thermal switch 1104 of the breaker 1112 is in an open configuration, current can flow through the thermal sensor element 1102 and the second thermal sensor element 1110. Similar to the second thermal sensor element 810, 910, 1010, as current passes through the second thermal sensor element 1110, the second thermal sensor element 1110 can generate heat due to its resistive properties to cause the thermal switch 1104 to trip to an open configuration when the temperature exceeds a characteristic threshold, and to move back to the normally closed condition from the open condition once the temperature falls below a reset threshold. In the open configuration, current flowing through the electrical system 1100 can pass through the thermal sensor element 1102 and second thermal sensor element 1110. Current passing through the second thermal sensor element 1110 can maintain the heat generation until the current is turned off, allowing the second thermal sensor element 1110 to cool off.

In some implementations, the electrical system 1100 can include a relay not shown connected to the first terminal (e.g., Terminal A) and to the thermally controlled electrical component 1108 described in FIG. 10A. The relay can include a power consumption device (e.g., Load L). The power consumption device can be similar and/or identical to power consumption device 106. During charging of the electrical system 1100, current can be flowing into Terminal A and out of Terminal B. During discharging of the electrical system 1100, current can flow out of Terminal A and into Terminal B.

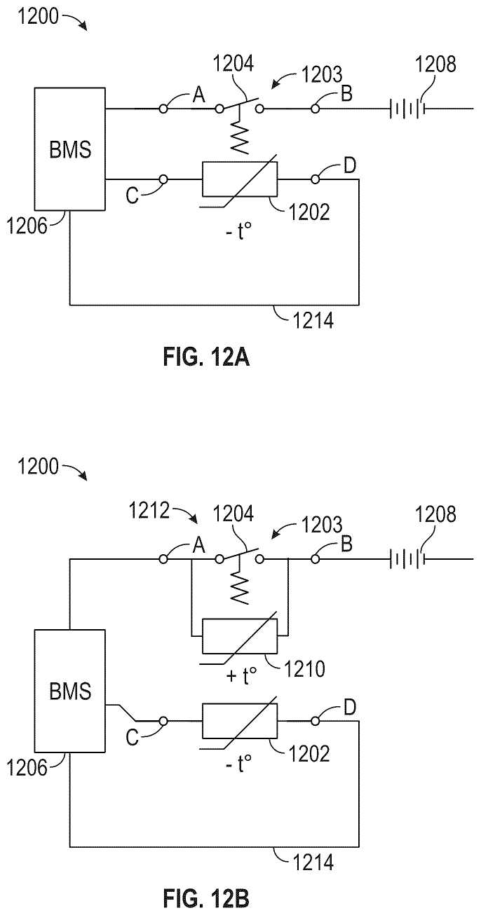

FIGS. 12A and 12B illustrate example schematic diagrams having a thermal switching device 1203 for electrical system 1200, according to some implementations. In FIG. 12A, the electrical system 1200 can include a thermal switch 1204, a thermal sensor element 1202, an electronic control device 1206, and a thermally controlled electrical component 1208 (e.g., a power supplying device) which can be similar or identical to those found in FIGS. 8A-11B. However, compared to the electrical systems found in FIGS. 8A-12B, the thermal switch 1204 and the thermal sensor element 1202 can be electrically isolated from one another such that there is no electrical connection and/or conductive path between the thermal switch 1204 and the thermal sensor element 1202. Thus, the thermal sensor element 1202 can also be known an electrically isolated thermal sensor unit. In some implementations, the electrically isolated thermal sensor element 1202 can include negative temperature coefficient thermistor (NTC). Electrical isolation can protect equipment from damage by preventing unintended and/or excessive current flow through parts of the electrical system 1200. By electrically isolating the thermal switch 1204 and the thermal sensor element 1202, a current (e.g., a high current such as above 10 A) can be passed through the thermal switch 1204 to the electronic control device 1206 and/or the thermally controlled electrical component 1208. Said current can either exceed the power rating of the thermal sensor element 1202 and/or produce enough ohmic heating to cause errors in the thermal sensor element 1202 reading. However, the thermal switch 1204 and the thermal sensor element 1202 can be thermally and mechanically connected in the same package to trip the switch from a normally closed configuration to an open configuration. Thus, current would not flow (or only a trickle of current would flow) between the electronic control device 1206 and the thermally controlled electrical component 1208. When the thermal switch 1204 of the thermal switching device 1203 is in an open configuration, a reading of the voltage and current can be taken across the thermal switching device 1203, particularly, the thermal sensor element 1202, to determine the resistance of thermal sensor element 1202 by the electronic control device 1206. The corresponding resistance value can be utilized by the electronic control device 1206 to calculate the temperature of the thermal sensor element 1202 and generate a signal. The signal can prompt a response from the electronic control device 1206 and/or another electrical device. According to some implementations, the electrical system 1200 can provide accurate readings connected to a power consuming device or load such as a motor. The electrical system 1200 can further include a voltage sense wire 1214 connecting to the electronic control device 1206 to the negative voltage sense terminal.

FIG. 12B is another schematic diagram of a portion of an electrical system 1200, according to various implementations. In FIG. 12B, the electrical system 1200 of FIG. 12B can be similar and/or identical to the electrical system 1200 of FIG. 12A except that the electrical system 1200 can include a second thermal sensor element 1210. The second thermal sensor element 1210 and thermal switch 1204 can form a breaker 1212. The breaker 1212 and the thermal sensor element 1202 can be connected in parallel. The breaker 1212 and the thermal sensor element 1202 can be connected in parallel with the thermal switch 1204. When the thermal switch 1204 of the breaker 1212 is open, current can flow through the thermal sensor element 1202 and the second thermal sensor element 1210. Similar to the second thermal sensor element 810, 910, 1010, 1110, as current passes through the second thermal sensor element 1210, the second thermal sensor element 1210 can generate heat due to its resistive properties to cause the thermal switch 1204 to trip to an open configuration when the temperature exceeds a characteristic threshold, and to move back to the normally closed condition from the open condition once the temperature falls below a reset threshold. In the open configuration, current flowing through the electrical system 1200 can pass through the thermal sensor element 1202 and second thermal sensor element 1210. Current passing through the second thermal sensor element 1210 can maintain the heat generation until the current is turned off, allowing the second thermal sensor element 1210 to cool off. When the thermal switch 1204 of the thermal switching device 1203 is in an open configuration, a reading of the voltage and current can be taken across the thermal switching device 1203, particularly, the thermal sensor element 1202, to determine the resistance of thermal sensor element 1202 by the electronic control device 1206. The corresponding resistance value can be utilized by the electronic control device 1206 to calculate the temperature of the thermal sensor element 1202 and generate a signal. The signal can prompt a response from the electronic control device 1206 and/or another electrical device. According to some implementations, the electrical system 1200 can provide accurate readings connected to a power consuming device or load such as a motor.

In some implementations, the electrical system 1200 in FIGS. 12A and 12B can include a relay not shown connected to the first terminal (e.g., Terminal A) and to the thermally controlled electrical component 1208 as described in FIG. 10A. The relay can include a power consumption device (e.g., Load L). The power consumption device can be similar and/or identical to power consumption device 106. During charging of the electrical system 1200, current can be flowing into Terminal A and out of Terminal B. During discharging of the electrical system 1200, current can flow out of Terminal A and into Terminal B.

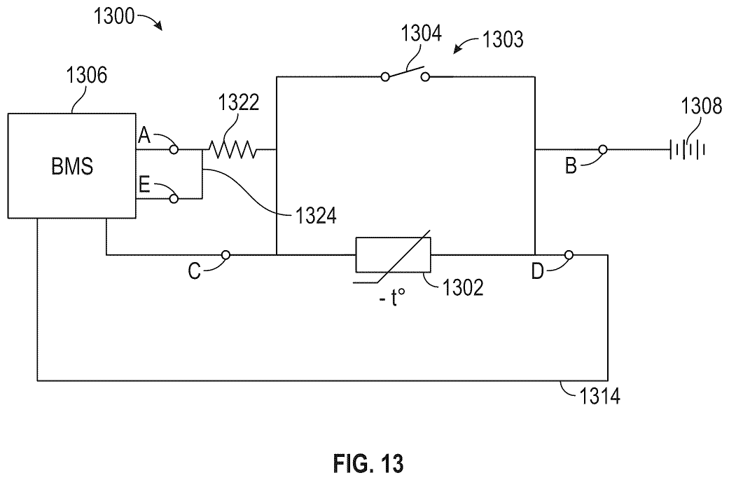

FIG. 13 illustrates an example schematic diagram having a thermal switching device 1303 device for electrical system 1300, according to some implementations. The electrical system 1300 can be similar or identical to the electrical system shown in FIGS. 10A-12B. The electrical system 1300 can include a thermal switching device 1303 having a thermal sensor element 1302 and a thermal switch 1304, an electronic control device 1306, a thermally controlled electrical component 1308 (e.g., a power supplying device), and a voltage sensing line 1314. The electrical system 1300 can further include Terminals A, B, C, and D as found in the electrical systems of FIGS. 10A-12B. However, the electrical system 1300, as shown in FIG. 13, can include a thermistor 1322 in series with the thermal sensor element 1302 and the thermal switch 1304. Further, the electrical system 1300 can include an additional voltage sensing terminal (i.e., Terminal E (vₛₑₙₛₑ₋)) between the electronic control device 1306 and the thermistor 1322 for measuring the voltage drop across the thermistor 1322. The additional Terminal E can add another voltage sense line 1324. The thermistor 1322 can be electrically connected to Terminal A and/or Terminal E. The thermistor 1322 can be a low temperature coefficient of resistance (TCR) thermistor. A voltage drop between Terminal E and Terminal C can be measured across the thermistor 1322 to be used as a determined by the electronic control device 1306. When the thermal switch 1304 of the thermal switching device 1303 is in an open position, a reading of the voltage and current can be taken across the thermal switching device 1303, particularly, the thermal sensor element 1302, to determine the resistance of thermal sensor element 1302 by the electronic control device 1306. The corresponding resistance value can be utilized by the electronic control device 1306 to calculate the temperature of the thermal sensor element 1302 and generate a signal. The signal can prompt a response from the electronic control device 1306 and/or another electrical device. According to some implementations, the electrical system 1300 can provide accurate readings connected to a power consuming device such as a motor.

In some implementations, the electrical system 1300 can include a relay not shown connected to the first terminal (e.g., Terminal A) and to the thermally controlled electrical component 1308 described in FIG. 10A. The relay can include a power consumption device (e.g., Load L). The power consumption device can be similar and/or identical to power consumption device 106. During charging of the electrical system 1300, current can be flowing into Terminal A and out of Terminal B. During discharging of the electrical system 1300, current can flow out of Terminal A and into Terminal B.

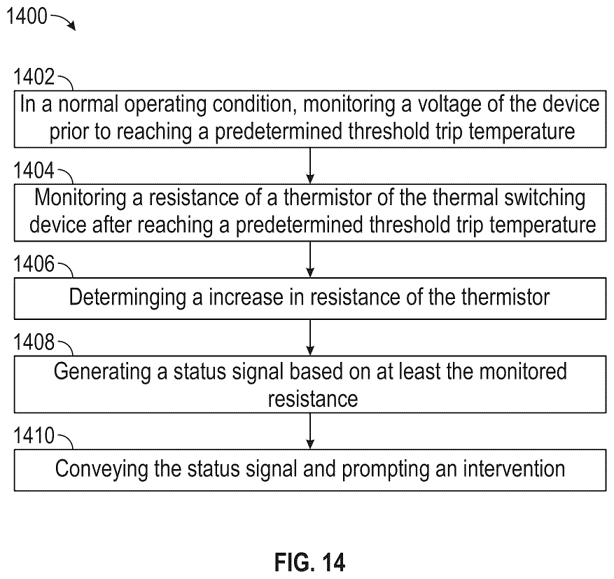

FIG. 14 illustrates an example process 1400 of any of the electrical systems mentioned herein for determining a temperature of a connector body configured to be mechanically connected to a device. At block 1402, in a normal operating condition of a thermal switching device, an electrical system can monitor a voltage of a device prior to the device reaching a predetermined overcurrent threshold. A current can normally flow through a thermally activated switch element of the thermal switching device when the thermally activated switch element is a closed configuration. In the normal operating condition, circuitry can monitor a status signal of the thermal switching device. Additionally, the process 1400 can provide a normal-temperature signal to the electrical device while in the normal operating condition of the thermal switching device. In some implementations, the process 1400 can include flowing a current through a thermally activated switch element of the thermal switching device. The thermally activated switch element can be in parallel with a thermistor. The thermal switching device can be connected to the connector body. The process 1400 can further include transitioning the thermally activated switch element to an open configuration.

At block 1404, in a fault condition of the thermal switching device, once the predetermined threshold temperature is reached, the thermally activated switch element can transition to an open configuration in which the current passes through the thermistor instead of the thermally activated switch element. The circuitry of the BMS and/or electrical control device can monitor the resistance of the thermistor and/or the thermal switching device. The circuitry can determine an increase and/or decrease in the monitored resistance of the thermistor. As the current passes through the thermistor, the temperature of the thermistor can increases causing the resistance to either increase or decrease, depending on the type of thermistor.

At block 1406, the circuitry of the electrical control device can determine the temperature of the thermistor and the thermally controlled electrical component in electrical and mechanical connection with the thermal switching device, for example a power supply, by measuring the resistance of the thermistor. The temperature can be based at least on the monitored resistance of a thermistor of the thermal switching device after the thermal switching device reaches a predetermined threshold trip temperature and switches to the fault condition. In calculating the temperature using the circuitry of the BMS, the voltage is measured across the thermistor and/or the thermal switching device. The measured voltage is converted into a corresponding resistance value. For example, the corresponding resistance value can be determined from the equation R=V/I, where R is the corresponding resistance value, V is the voltage measured across the thermistor and/or the thermal switching device, and I is the current flowing through the thermistor and/or the thermal switching device. The corresponding resistance value of the thermal switching device can be set for specific applications of the electrical system. The circuitry of the BMS can utilize the corresponding resistance value to determine a temperature value. For example, based on a plot (which can be programmed into the circuitry of the BMS), a temperature value can be identified from the corresponding resistance value. The temperature value can accurately represent the overtemperature value of the thermally controlled electrical component in electrical and mechanical connection with the thermal switching device, e.g. a power supply. Furthermore, the temperature monitoring can beneficially be performed on a high temperature portion of a curve (i.e., after tripping of the switch) in which the resistance-temperature can have an approximately linear relationship.

At block 1408, the circuitry of the electrical control device can generate a status signal based on at least the monitored resistance. At block 1410 a status signal is conveyed from the electrical device, prompting an intervention. In some implementations, prompting the intervention can include generating an alarm. Additionally, or alternatively, prompting the intervention can include disconnecting the thermally controlled electrical component from a power source and-or from other parts of the circuit. In some implementations, the process 1400 can include resetting the thermal switching device. The thermal switching device can be manually resettable. For example, the thermal switching device can include a user interface to manually reset the thermal switching device when engaged by a user. In other implementations, the thermal switching device can be automatically resettable. For example, the thermal switching device can automatically reset to a resistance less than 0.1 ohms.

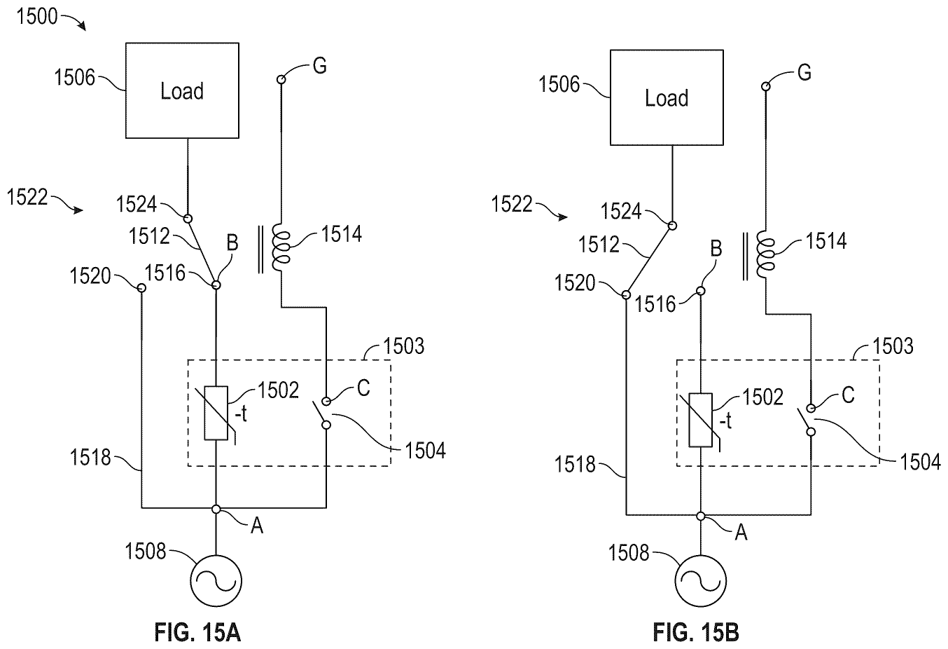

FIGS. 15A-15B illustrate example schematic diagrams of electrical system 1500 for managing overcurrent conditions from an inrush current event having a thermal switching device 1503, according to various implementations. FIG. 15A illustrates the electrical system 1500 in an inrush current limiting state. FIG. 15B illustrates the electrical system 1500 in a normal operating state. Unless otherwise noted, the components of FIGS. 15A-15B can be the same as or generally similar to like-numbered components of FIGS. 8A-13.

For example, the electrical system 1500 can comprise a power supply 1508 to supply power to electronic device 1506, such as an electric automobile, an electric bicycle, an electric power tool, etc. The illustrated power supply 1508 comprises an alternating current (AC) power supply, but in various embodiments, other power supplies, such as direct current (DC) power supplies (e.g., batteries) can be used. A relay 1522 can be positioned between the power supply 1508, the thermal switching device 1503, and the electronic device 1506. In some implementations, the relay 1522 can include additional contacts as some latching circuits can utilize double pole relays. The relay can include a first terminal 1516, a second terminal 1520, and a third terminal 1524 connected to the electronic device 1506. A latching circuit is a type of electronic circuit that can lock into one of two stable states and stay in that state until it receives a specific signal to switch to the other state. A latching circuit can be similar to a switch that will turn on or off once and will stay in that position until another input changes it. The relay 1522 can include a switch element 1512 positioned between the first terminal 1516, the second terminal 1520, and the third terminal 1524 and an electromagnetic coil 1514 which then connected to a ground terminal G. In some implementations, the thermal switching device 1503 can include a plurality of terminals. For example, as shown in FIGS. 15A and 15B, the thermal switching device 1503 can include three terminals, a first terminal A, a second terminal B, and a third terminal C. The first terminal A can connect the power supply 1508 to the thermal switching device 1503. The second terminal B can connect the thermal switching device 1503 to a first terminal 1516 of the relay 1522. The third terminal C can connect the thermal switching device 1503 to the electromagnetic coil 1514. A bypass line 1518 can connect the power supply 1508 to the second terminal 1520 of the relay 1522.

Accordingly, in the implementation of FIGS. 15A-15B, the thermal switching device 1503 can be provided to protect against the initial inrushes of current (e.g., turning on a power source, hot swapping of a battery, etc.). The thermal switching device 1503 can include a normally open thermal switch 1504 in parallel and thermal communication with a thermal sensor element 1502, along the electrical pathway between the power supply 1508 and the electronic device 1506. As with the implementations above, the normally open thermal switch 1504 can include a thermally or electrically activated mechanical switch, for example a bimetallic element, such as a dome-shaped bimetallic element that can flip positions when the temperature of the element exceeds a predetermined threshold. The thermal sensor element 1502 can include any suitable type of thermistor (e.g., PTC, NTC, etc.). In the illustrated embodiment, the thermal sensor element 1502 comprises an NTC thermistor. In some implementations, the thermal sensor element 1502 may not include a PTC thermistor. In other implementations, the thermal sensor element 1502 may comprise a PTC thermistor.

In the implementations of FIG. 15A, the thermal switch 1504 is initially in the open configuration, which is shown in FIG. 15A. When the power supply 1508 is activated, the inrush of current can pass through the thermal sensor element 1502, as shown in FIG. 15A. The thermal switch 1504 (e.g., a thermally activated switch) may be thermally connected to the thermal sensor element 1502 (e.g., may be packaged with and/or contacting the thermal sensor element 1502) such that, as the current passes through the thermal sensor element 1502, the temperature of the thermal sensor element 1502 rises. The initial inrush of current can therefore be significantly reduced by the thermal sensor element 1502 so as to lower the current that passes along the second terminal B to electronic device 1506, mitigating or preventing damage to the electronic device 1506 during the initial inrush of current.

When the temperature of the thermal switch 1504 and/or the thermal sensor element 1502 (and/or current through the thermal sensor element 1502) exceeds the predetermined threshold, then the thermal switch 1504 can switch to the closed position, as shown in FIG. 15B, thereby bypassing the thermal sensor element 1502 (e.g., during an operational configuration). The thermal sensor element 1502 can be selected to have resistance properties sufficient to reduce the inrush of current to levels that do not damage the electronic device 1506 during the time period of the inrushing current, which may be a relatively short period of time (e.g., on the order of milliseconds). The current can then pass through the third terminal C to the electromagnetic coil 1514. The electromagnetic coil 1514 can then energize, mechanically causing the relay 1522 to switch from the first terminal 1516 connected to the thermal sensor element 1502 to the second terminal 1520 connected to the bypass line 1518. The current supplied by the power supply 1508 then bypasses the thermal switching device 1503 along the bypass line 1518 to the electronic device 1506. Accordingly, when the thermal switch 1504 moves to the closed position, the current passing through the electrical system 1500 may be at levels that can be accommodated by the electronic device 1506. The lower current (e.g., after the thermal sensor element 1502 has sufficiently reduced the inrush current) can pass through the closed thermal switch 1504 and into the electronic device 1506.

In some implementation, the normally open thermal switch 1504 may be non-resettable such that the thermal switch 1504 is configured to not automatically move back to the open configuration shown in FIG. 15A after it moves to the closed configuration. In some implementations, the thermal switch 1504 may be manually resettable. For example, a button and/or mechanical linkage can be provided on the thermal switching device 1503, such that the user can manually reset the normally open thermal switch 1504 to the open position. In still other implementations, the thermal sensor element 1502 can comprise a PTC thermistor, which can allow the normally open thermal switch 1504 to be automatically resettable for some applications. In some implementations, the thermal switch 1504 can remain in closed configuration and the relay 1522 connected to the 1520 while power is supplied to the electrical system 1500. Once the power is turned off, the system to return to the configuration of FIG. 15A. In other implementations, the thermal switch 1504 can momentarily close, allowing the electromagnetic coil 1514 to generate a magnetic field to switch the relay 1522 from the first terminal 1516 to the second terminal 1520 (e.g., bypass terminal).

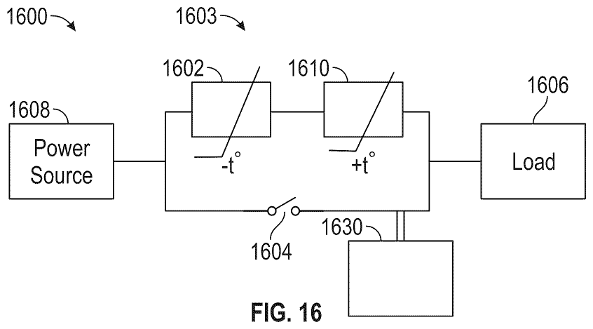

FIG. 16 illustrates an example schematic diagram of electrical system 1600 for managing overcurrent conditions from an inrush current event having one or more thermal switching devices 1603, according to various implementations. For example, the electrical system 1600 can include a power supplying device 1608 to supply power to an electronic device (LOAD L) 1606, such as a motor, battery management system (BMS), an electric automobile, an electric bicycle, an electric power tool, etc. In some implementations, the power supplying device 1608 can include an alternating current (AC) source that generates an electrical current that periodically reverses its direction. A thermal switching device 1603 can be positioned between the power supplying device 1608 and the electronic device (Load) 1606. Accordingly, in the implementation of FIG. 16, the thermal switching device 1603 can be provided to protect against the initial inrushes of current (e.g., turning on a power source, hot swapping of a battery, etc.). The thermal switching device 1603 can include a normally open thermal switch 1604 (which may also be referred to herein as a thermal switch and/or thermally activated switch) in parallel and thermal communication with a thermal sensor element 1602 and a second thermal sensor element 1610, along the electrical pathway between the power supplying device 1608 and the electronic device 1606. The thermal sensor element 1602 and the second thermal sensor element 1610 can be connected in series. The normally open thermal switch 1604 can include a thermally activated mechanical switch, for example a bimetallic element, such as a dome-shaped bimetallic element that can flip positions when the temperature of the element exceeds a predetermined threshold. The thermal sensor element 1602 and the second thermal sensor element 1610 can include any suitable type of thermistor (e.g., PTC, NTC, etc.). For example, as shown in FIG. 16, the thermal sensor element 1602 can comprise a NTC thermistor and the second thermal sensor element 1610 can comprise a PCT thermistor. In some implementations, the thermal sensor element 1602 and the second thermal sensor element 1610 cannot include a PTC thermistor. In other implementations, the thermal sensor element 1602 and the second thermal sensor element 1610 can include a PTC thermistor. In some implementations, the electrical system 1600 can include a microcontroller 1630 to indicate whether the thermal switch 1604 of the thermal switching device 1603 is in an open and/or closed configuration.

In the implementations of FIG. 16, the thermal switch 1604 is initially in the open configuration and the thermal sensor element 1602 and the second thermal sensor element 1610 can be in at room temperature (e.g., 20-25° C.; 68-77° F.), which is shown in FIG. 16. When the power supplying device 1608 is activated, the inrush of current can pass through the thermal sensor element 1602 and/or the second thermal sensor element 1610. The switch 1604 (e.g., a thermally activated switch) may be thermally connected to the thermal sensor element 1602 and/or the second thermal sensor element 1610 (e.g., may be packaged with and/or contacting the thermal sensor element 1602 and/or the second thermal sensor element 1610) such that, as the current passes through the thermal sensor element 1602 and/or the second thermal sensor element 1610, the temperature of the thermal sensor element 1602 and/or the second thermal sensor element 1610 can rise. The initial inrush of current can therefore be significantly reduced by the thermal sensor element 1602 and/or the second thermal sensor element 1610 so as to lower the current to electronic device 1606, mitigating or preventing damage to the electronic device 1606 during the initial inrush of current.

When the temperature of the thermally activated switch 1604, thermal sensor element 1602, and/or the second thermal sensor element 1610 (and/or current through the thermal sensor element 1602 and/or the second thermal sensor element 1610) exceeds the predetermined threshold, then the thermally activated switch 1604 can switch to the closed connection, thereby bypassing the thermal sensor element 1602 and the second thermal sensor element 1610 (e.g., during an operational configuration). The thermal sensor element 1602 and/or second thermal sensor element 1610 can be selected to have resistance properties sufficient to reduce the inrush of current to levels that do not damage the electronic device 1606 during the time period of the inrushing current, which may be a relatively short period of time (e.g., on the order of milliseconds). Accordingly, when the thermally activated switch 1604 moves to the closed position, the current passing through the electrical system 1600 may be at levels that can be accommodated by the electronic device 1606. The lower current (e.g., after the thermal sensor element 1602 and/or second thermal sensor element 1610 has sufficiently reduced the inrush current) can pass through the closed thermally activated switch 1604 and into the electronic device 1606. In some implementations, as the current continues to pass through the thermal sensor element 1602 and/or second thermal sensor element 1610, the thermal sensor element 1602 and/or second thermal sensor element 1610 can continuously generate heat to maintain the thermally activated switch 1604 in the closed configuration. In some implementations, as the current passes through the thermal sensor element 1602, the thermal sensor element 1602 can generate heat and can dissipate the heat quickly, which does not affect the thermally activated switch 1604. Rather, as the current continues through the second thermal sensor element 1610, the second thermal sensor element 1610 can generate sufficient heat to cause the switch 1604 to switch from an open configuration to a closed configuration. Additionally, the second thermal sensor element 1610 can be continuously apply heat to the switch 1604 to maintain the thermally activated switch 1604 in a closed configuration.

In some implementation, the thermally activated switch 1604 may be non-resettable such that the switch 1604 is configured to not automatically move back to the open configuration after it moves to the closed configuration. In some implementations, the thermally activated switch 1604 may be manually resettable. For example, a button and/or mechanical linkage can be provided on the thermal switching device 1603, such that the user can manually reset the normally open switch 1604 to the open position. In still other implementations, the thermal sensor element 1602 and/or second thermal sensor element 1610 can comprise a PTC thermistor and/or NTC thermistor, which can allow the normally open thermally activated switch 1604 to be automatically resettable for some applications. In some implementations, the switch 1604 can remain in closed configuration while power is supplied to the electrical system 1600. Once the power is turned off, the switch 1604 can return to its normally open configuration.

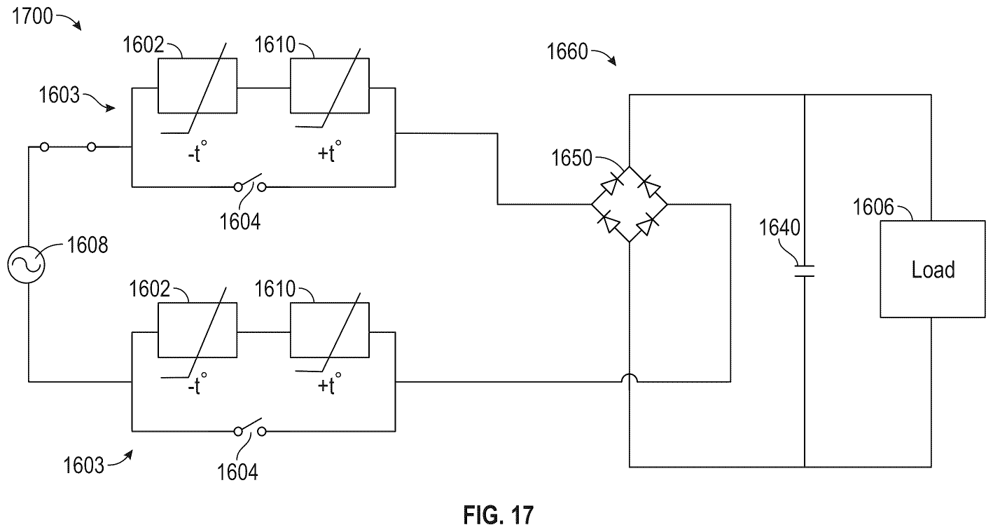

FIG. 17 illustrates an example schematic diagram of electrical system 1700 of an application for managing overcurrent conditions from an inrush current event having one or more thermal switching devices 1603, according to various implementations. For example, the electrical system 1700 can include thermal switching devices 1603 positioned on either side of the power supplying device 1608. In some implementations, a thermal switching device 1603 can be placed on one side of the power supplying device 1608 but not the other. The thermal switching devices 1603 can then be electrically connected to a rectifying circuit 1660 that converts alternating current (AC) from the power supplying device 1608 into direct current (DC). The process of rectification involves allowing the flow of current in only one direction while blocking the current in the opposite direction. The rectifying circuit 1660 can include a diode bridge 1650 having an arrangement of diodes to convert alternating current (AC) into direct current (DC), a capacitor 1640 electrically connected in parallel to the diode bridge 1650, and an electronic device 1606 (e.g., Load) can be connected in parallel to the capacitor 1640. The diode bridge 1650 can allow the positive portion of an AC waveform to pass through while blocking the negative portion, effectively converting the AC signal into a unidirectional (DC) signal. The diode bridge 1650 can include four diodes arranged in a pattern.

Similar to the implementation of FIG. 16, the thermal switching device 1603 can be provided to protect against the initial inrushes of current (e.g., turning on a power source, hot swapping of a battery, etc.). The thermal switching device 1603 can include a normally open thermally activated switch 1604 in parallel and thermal communication with a thermal sensor element 1602 and a second thermal sensor element 1610, along the electrical pathway between the power supplying device 1608 and the electronic device (Load) 1606.

In the implementations of FIG. 17, the thermally activated switches 1604 are initially in the open configuration and the thermal sensor elements 1602 and the second thermal sensor elements 1610 can be at room temperature (e.g., 20-25° C.; 68-77° F.), which is shown in FIG. 17. When the power supplying device 1608 is activated, the inrush of current can pass through the thermal sensor element 1602 and/or the second thermal sensor element 1610. The thermally activated switches 1604 may be thermally connected to the thermal sensor element 1602 and/or the second thermal sensor element 1610 (e.g., may be packaged with and/or contacting the thermal sensor element 1602 and/or the second thermal sensor element 1610) such that, as the current passes through the thermal sensor element 1602 and/or the second thermal sensor element 1610, the temperature of the thermal sensor element 1602 and/or the second thermal sensor element 1610 can rise. The initial inrush of current can therefore be significantly reduced by the thermal sensor element 1602 and/or the second thermal sensor element 1610 so as to lower the current to the diode bridge 1650, capacitor 1640, and/or electronic device 1606 mitigating or preventing damage to the diode bridge 1650, capacitor 1640, and/or electronic device 1606 during the initial inrush of current.

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain implementations and examples, it will be understood by those skilled in the art that the various implementations of the systems and processes extend beyond the specifically disclosed implementations to other alternative implementations and/or uses of the systems and processes and obvious modifications and equivalents thereof. In addition, while several variations of the implementations of the systems and processes have been shown and described in detail, other modifications, which are within the scope of this disclosure, will be readily apparent to those of skill in the art based upon this disclosure. It is also contemplated that various combinations or sub-combinations of the specific features and implementations of the implementations may be made and still fall within the scope of the disclosure. It should be understood that various features and implementations of the disclosed implementations can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative implementations, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate implementations also may be implemented in combination in a single implementations. Conversely, various features that are described in the context of a single embodiment also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Moreover, as used herein, when a first element is described as being “on” or “over” a second element, the first element may be directly on or over the second element, such that the first and second elements directly contact, or the first element may be indirectly on or over the second element such that one or more elements intervene between the first and second elements. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain implementations include, while other implementations do not include, certain features, elements and/or states. Thus, such conditional language is not generally intended to imply that features, elements and/or states are in any way required for one or more embodiments.

While certain implementations have been described, these implementations have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative implementations may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further implementations. The accompanying claims and their equivalents are intended to cover such forms or modifications as would fall within the scope and spirit of the disclosure.

Several illustrative examples of thermal cutoff elements and devices and related systems and methods have been disclosed. Although this disclosure has been described in terms of certain illustrative examples and uses, other examples and other uses, including examples and uses which do not provide all of the features and advantages set forth herein, are also within the scope of this disclosure. Components, elements, features, acts, or steps may be arranged or performed differently than described and components, elements, features, acts, or steps may be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations may also be implemented in combination in a single implementation. Conversely, various features that are described in the context of a single implementation also may be implemented in multiple implementations separately or in any suitable subcombination. Moreover, although features may be described above as acting in certain combinations, one or more features from a claimed combination may in some cases be excised from the combination, and the combination may be claimed as a subcombination or variation of a subcombination.

Further, while illustrative examples have been described, any examples having equivalent elements, modifications, omissions, and/or combinations are also within the scope of this disclosure. Moreover, although certain aspects, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures may or may not be drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components may be added, removed, and/or rearranged. Further, the disclosure herein of any particular feature, aspect, method, property, characteristic, quality, attribute, element, or the like in connection with various examples may be used in all other examples set forth herein. Additionally, any methods described herein may be practiced using any device suitable for performing the recited steps.

For purposes of summarizing the disclosure, certain aspects, advantages and features of the inventions have been described herein. Not all, or any such advantages are necessarily achieved in accordance with any particular example of the inventions disclosed herein. No aspects of this disclosure are essential or indispensable. In many examples, the devices, systems, and methods may be configured differently than illustrated in the figures. or description herein. For example, various functionalities provided by the illustrated modules may be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification may be included in any example.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the implementations shown herein but are to be accorded a fair interpretation consistent with this disclosure, the principles and the novel features disclosed herein.

1.-102. (canceled)

103. A temperature-sensitive connector, comprising:
a connector body comprising a first terminal configured to mechanically and electrically connect with a thermally controlled electrical component and a second terminal configured to mechanically and electrically connect with an electrical thermal control device;
at least one conductor within the connector body and connected to the first and second terminals and configured to convey electrical current and electrical signals between the thermally controlled electrical component and the electrical thermal control device; and
a thermal switching device within the connector body mechanically and electrically connected by the conductor to the first and second terminals, the thermal switching device comprising a thermally activated switch element connected mechanically and electrically in parallel by a pair of internal conductors to a thermal sensor element having a variable resistance;
wherein the thermal switching device has a normal operating configuration in which a majority of the current flows through the thermally activated switch element, thereby generating normal status signal indicating that the thermally controlled electrical component is operating within a predetermined temperature range; and
wherein the thermal switching device has a fault condition triggered at a predetermined threshold temperature in which the thermally activated switch element switches to an open configuration, thereby generating a first thermal alert status signal that the threshold temperature has been exceeded, and in which the current flows through the thermal sensor element, thereby generating a second thermal alert status signal indicative of a temperature of the thermally controlled electrical component.

104. The temperature-sensitive connector of claim 103, wherein the temperature-sensitive connector is configured to be attached to circuitry configured to implement interventions based at least in part on the generated normal thermal status signal, the first thermal alert status signal, and the second thermal alert status signals.

105. The temperature-sensitive connector of claim 104, wherein the intervention associated with the determined temperature initiates a response by the thermally controlled electrical component to perform an action, wherein the action comprises disconnecting the thermally controlled electrical component from a power source.

106. The temperature-sensitive connector of claim 103, wherein the thermally activated switch element comprises at least one of a thermal cutoff (TCO) and a bimetal thermal cutoff (TCO).

107. The temperature-sensitive connector of claim 103, wherein the thermal sensor element comprises a thermistor, and wherein the thermistor comprises at least one of a ceramic positive temperature coefficient thermistor (PTC), ceramic negative temperature coefficient thermistor (NTC), polymeric PTC, and silicon silistor.

108. The temperature-sensitive connector of claim 103, further comprising a thermal sensing device, wherein the thermal sensing device comprises two or more terminals and a second thermal sensor element, wherein the second thermal sensor element is not electrically connected to the thermal switching device.

109. The temperature-sensitive connector of claim 108, wherein the second thermal sensor element of the thermal sensing device comprises an NTC, wherein the thermal sensing device comprises at least two terminals for conducting current and two electrically independent terminals for voltage measurement, and wherein an average of value of the resistance of the thermal switching device and a resistance of the NTC is configured to calculate the temperature of the temperature-sensitive connector.

110. The temperature-sensitive connector of claim 103, wherein the thermally activated switch element is manually resettable.

111. The temperature-sensitive connector of claim 103, wherein the thermally activated switch element is automatically resettable.

112. The temperature-sensitive connector of claim 103, wherein the thermal switching device comprises a second thermal sensor element in parallel with the thermally activated switch element, wherein the second thermal sensor element comprises an NTC, a PTC, a silistor, or a thermal temperature sensor.

113. The temperature-sensitive connector of claim 112, wherein the second thermally activated switch element is electrically connected to the thermally activated switch element in series.

114. The temperature-sensitive connector of claim 112, wherein the second thermal sensor element generates heat as a current passes through the second thermal sensor element to cause the thermally activated switch element to trip to an open configuration when the temperature exceeds a characteristic threshold and switches to a closed condition from the open condition once the temperature falls below a reset threshold.

115. A thermal cutoff element (TCO) configured to provide a signal to an electrical thermal control device, the TCO comprising:
a thermally activated switch element, and
a thermal sensor element in parallel with the thermally activated switch element and in electrical and mechanical connection with the thermally activated switch element;
wherein the thermally activated switch element has a first operating condition in which a signal is conveyed by the TCO to the electrical thermal control device comprises a voltage status signal, and the thermally activated switch has a second operating condition in which circuitry of the electrical thermal control device determines a temperature of a portion of a device being thermally controlled based at least in part on a measured resistance of the thermal sensor element.

116. The TCO of claim 115, wherein the thermal sensor element comprises a negative temperature coefficient thermistor (NTC), a positive temperature coefficient thermistor (PTC), a silistor, or a thermal temperature sensor.

117. The TCO of claim 115, wherein the thermally activated switch element is manually resettable.

118. The TCO of claim 115, wherein the thermally activated switch element is automatically resettable.

119. The TCO of claim 115, wherein the thermally activated switch element comprises a bimetallic dome-shaped switch element.

120. The TCO of claim 115, wherein the circuitry is configured to generate a status signal based on the determined temperature, wherein the status signal initiates a response by the electrical thermal control device to perform an action, and wherein the response associated with the determined temperature initiates a warning alarm to an operator.

121. The TCO of claim 115, wherein the thermal switching device comprises a second thermal sensor element in parallel with the thermally activated switch element, and wherein the second thermal sensor element is electrically connected to the thermal sensor element in series.

122. The TCO of claim 121, wherein the second thermal sensor element generates heat as a current passes through the second thermal sensor element to cause the thermally activated switch element to trip to an open configuration when the temperature exceeds a characteristic threshold and switches to a closed condition from the open condition once the temperature falls below a reset threshold.

123. The TCO of claim 121, wherein the second thermal sensor element comprises a negative temperature coefficient thermistor (NTC), a positive temperature coefficient thermistor (PTC), a silistor, or a thermal temperature sensor.
